(19) United States
(12) Patent Application Publication
(10) Pub. No.: US 2025/0232194 A1
(43) Pub. Date: Jul. 17, 2025

(54) GENERALIZED FUNCTION LEARNING MACHINE

(71) Applicant: The Regents of the University of Colorado, Denver, CO (US)

(72) Inventors: David Bortz, Boulder, CO (US); Vanja Dukic, Boulder, CO (US); Daniel Messenger, Boulder, CO (US)

(73) Assignee: The Regents of the University of Colorado, Denver, CO (US)

(21) Appl. No.: 19/020,948

(22) Filed: Jan. 14, 2025

Related U.S. Application Data
(60) Provisional application No. 63/621,086, filed on Jan. 15, 2024.

(51) Int. Cl. G06N 5/04; G06F 17/13

(52) U.S. Cl. CPC G06N 5/04; G06F 17/13

(57) ABSTRACT

The system and methods of the present invention involve estimating model parameters for non-linear systems of Differential Equations (DEs). This includes receiving data from these systems and applying Weak-form Estimation of Nonlinear Dynamics methods to the data. These methods are robust to instances of large measurement noise. The system and methods also involve converting strong form representations of a model to weak forms, solving regression problems to perform parameter inference, and using Errors-In-Variables frameworks and iteratively reweighted least squares algorithms. The system and methods of the present invention can be applied to various models from different fields such as population biology, neuroscience, and biochemistry. The system and methods are highly robust and exhibit computational efficiency when used to estimate parameters in some common models including logistic growth, Lotka-Volterra, FitzHugh-Nagumo, Hindmarsh-Rose, a Protein Transduction Benchmark model and Kuramoto-Sivashinsky.

### STATEMENT OF FEDERALLY SPONSORED RESEARCH

This invention was made with government support under grant number R01 GM126559 awarded by the National Institutes of Health, grant numbers MCB2054085 and DEB2109774 awarded by the National Science Foundation, grant number DE-SC0023346 awarded by the US Department of Energy, DEB2109774 awarded by the National Science Foundation, and grant number 2019-67014-29919 awarded by the US Department of Agriculture. The government has certain rights in the invention.

### BACKGROUND OF THE INVENTION

### 1. Technical Field

The present invention relates generally to the field of artificial intelligence-based modeling systems and more particularly relates to the learning of model parameters for non-linear systems of governing equations as described by differential equations.

### 2. Background Art

Constitutive parameters in differential equations have been learned either analytically or computationally and in many cases the challenge in doing so can be significant. For example, learning parameters is conditioned on assumptions concerning the resolution and fidelity of the data, as well as the accuracy of the computationally generated solution to the differential equation, as well as the quality of the non-linear optimization algorithm. In the field of data-driven modeling, using artificial intelligence to learn model parameters for non-linear systems of differential equations (ordinary, partial, and stochastic) can be a significant challenge. Traditional methods often rely on numerical differential equation solvers, which can be computationally intensive and may not provide accurate estimates, especially in the presence of large levels of measurement noise. Furthermore, these methods may struggle with higher dimensional and stiff systems, leading to inefficiencies in both speed and accuracy.

Additionally, it is most common to use the so-called “strong” form representation of a model, which computes a weighted average value over time and space as opposed to a “weak” form which computes an average value over a region. Moreover, in addition to the challenges detailed above, the computational problems are further compounded when dealing with the Errors-In-Variables regression framework, which is used in statistical analysis of these models.

To perform parameter learning, the approximate solution must be computed for proposed parameter values and then valuation of the loss function involves computing a least squares difference between model and data. Learning of the parameters in a fully nonlinear model involves iteratively updating the proposed parameter values, leading to a minimization of the loss function. This is particularly relevant when dealing with models from various scientific, engineering, and medical fields, where accurate parameter estimation is crucial to ensure the validity and reliability of the models.

Therefore, there is a clear need for a more efficient and accurate method for estimating model parameters for non-linear systems of (ordinary, partial, stochastic) differential equations, particularly in the context of noisy data.

### SUMMARY OF THE INVENTION

In accordance with one or more preferred embodiments of the present invention, a method is provided for estimating model parameters for non-linear systems of Differential Equations (DEs). The method involves receiving data from one or more measurement devices and applying one or more Weak-form Estimation of Nonlinear Dynamics (WENDy) methods to the received data. Note that in the creation of the weak form, a so-called “generalized function” is defined by the data and acts on the test function to convert the model system to the weak form. These WENDy methods are robust to instances of large measurement noise. The method also includes converting strong form representations of a model to weak forms, solving regression problems to perform parameter inference, and using an Errors-In-Variables frameworks such as scientific, engineering, and biomedical fields employing compartment-based ordinary differential equation, spatio-temporally-based partial differential equations.

In accordance with other embodiments, a system is provided for estimating model parameters for non-linear systems of Differential Equations (DEs). The system comprises a data receiver configured to receive data from one or more measurement devices, a processor configured to apply one or more Weak-form Estimation of Nonlinear Dynamics (WENDy) methods to the received data, and a memory configured to store one or more Errors-In-Variables frameworks and one or more iteratively reweighted least squares algorithms. The processor is also configured to convert strong form representations of a model to weak forms, solve regression problems to perform parameter inference, and create orthonormal test functions from Coo bump functions of varying support sizes. The system can handle both low dimensional systems with modest amounts of data and higher dimensional systems.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The various embodiments of the present invention will hereinafter be described in conjunction with the appended drawings, wherein like designations denote like elements, and:

FIG. 1 illustrates how the relative error changes as a function of test function radius mt (for different noise levels) for the Logistic Growth model in accordance with a preferred exemplary embodiment of the present invention;

FIG. 2 depicts a visualization of the minimum radius selection using single realizations of Fitzhugh-Nagumo data with 512 timepoints at three different noise levels, in accordance with a preferred exemplary embodiment of the present invention;

FIG. 3 depicts the first six orthonormal test functions obtained from Hindmarsh-Rose data with 2% noise and 256 timepoints in accordance with a preferred exemplary embodiment of the present invention;

FIG. 4 depicts histograms of the WENDy (red) and OLS (blue) residuals evaluated at the WENDy output wb applied to the (left-right) Logistic Growth, Lotka-Volterra, and Fitzhugh-Nagumo data, each with 256 timepoints and 20% noise in accordance with a preferred exemplary embodiment of the present invention;

FIG. 5 depicts an estimation of parameters in the Logistic Growth model in accordance with a preferred exemplary embodiment of the present invention;

FIG. 6 depicts estimation of parameters in the Lotka-Volterra model in accordance with a preferred exemplary embodiment of the present invention;

FIG. 7 depicts an estimation of parameters in the FitzHugh-Nagumo model in accordance with a preferred exemplary embodiment of the present invention;

FIG. 8 depicts an estimation of parameters in the Hindmarsh-Rose model in accordance with a preferred exemplary embodiment of the present invention;

FIG. 9 depicts an estimation of parameters in the Protein Transduction Benchmark (PTB) model in accordance with a preferred exemplary embodiment of the present invention;

FIG. 10 depicts performance of the WENDy process for all estimated parameters (FitzHugh-Nagumo) in accordance with a preferred exemplary embodiment of the present invention;

FIG. 11 depicts performance of the WENDy process for all estimated parameters (Hindmarsh-Rose) in accordance with a preferred exemplary embodiment of the present invention;

FIG. 12, FIG. 13, FIG. 14, and FIG. 15 depicts comparisons between FSNLS, WENDy-FSNLS, and WENDy for Lotka-Volterra, FitzHugh-Nagumo, Hindmarsh-Rose, and PTB models in accordance with a preferred exemplary embodiment of the present invention;

FIG. 16 depicts average performance of FSNLS, WENDy-FSNLS, and WENDy over Lotka-Volterra, FitzHugh-Nagumo, Hindmarsh-Rose and PTB for noise ratios σNR∈{0.01, 0.02, 0.05, 0.1} in accordance with a preferred exemplary embodiment of the present invention; and

### DETAILED DESCRIPTION OF THE INVENTION

### 1. Introductory Material

Accurate estimation of parameters for a given model is central to modern scientific discovery. It is particularly important in the modeling of biological systems which can involve both first principles-based and phenomenological models and for which measurement errors can be substantial, often in excess of 20%. The dominant methodologies for parameter inference are either not capable of handling realistic errors, or are computationally costly relying on forward solvers or Markov chain Monte Carlo methods. In this work, we propose an accurate, robust and efficient weak form-based approach to estimate parameters for parameter inference. We demonstrate that our “Weak form Estimation of Nonlinear Dynamics” (WENDy) method offers many advantages including high accuracy, robustness to substantial noise, and computational efficiency often up to several orders of magnitude over the existing methods.

In the remainder of this section, we provide an overview of modern parameter estimation methods in ODE systems, as well as a discussion of the literature that led to the WENDy idea. Section 2 contains the core weak-form estimation ideas as well as the WENDy algorithm itself. In Section 2.1, we introduce the idea of weak-form parameter estimation, including a simple algorithm to illustrate the idea. In Section 2.2, we describe the WENDy method in detail. We describe the Errors-In-Variables (EiV) framework, and derive a Taylor expansion of the residual which allows us to formulate the (in Section 2.2) Iteratively Reweighted Least Squares (IRLS) approach to inference. The EiV and IRLS modifications are important as they offers significant improvements to the Ordinary Least Squares approach. In Section 2.3, we present a strategy for computing an orthogonal set of test functions that facilitate a successful weak-form implementation. In Section 3 we illustrate the performance of WENDy using five common mathematical models from the biological sciences and in Section 4 we offer some concluding remarks.

### 1.1. Additional Background

A ubiquitous version of the parameter estimation problem in the biological sciences is

$$\hat{w} := arg {min}_{w ∈ {R}^{J}} {‖ u ( t ; w ) - U ‖}_{2}^{2} \qquad ( 1 )$$

where the function u:R→R^{d} is a solution to a differential equation model

$${u}^{\cdot } = {\sum }_{j = 1}^{J} {w}_{j} {f}_{j} ( u ) , u ( {t}_{0} ) = {u}_{0} ∈ {R}^{d} \qquad ( 2 )$$

The ODE system in (2) is parameterized by w∈R^{J}, the vector of J true parameters which are to be estimated by ŵ. The solution to the equation is then compared (in a least squares sense) with data U∈R^{(M+1)×d} that is sampled at M+1 timepoints t:={tᵢ}ᵢ₌₀^{M}. We note that in this work, we will restrict the differential equations to those with right sides that are linear combinations of the ƒⱼ functions with coefficients wⱼ, as in equation (2).

Conventionally, the standard approach for parameter estimation methodologies has been forward solver-based nonlinear least squares (FSNLS). In that framework: (i) a candidate parameter vector is proposed; (ii) the resulting equation is numerically solved on a computer; (iii) the output is compared (via least squares) to data; and (iv) then this process is repeated until a convergence criteria is met.

The FSNLS methodology is very well understood and its use is ubiquitous in the biological, medical, and bioengineering sciences. However, as models get larger and more realism is demanded of them, there remain several important challenges that do not have fully satisfying answers. For example, the accuracy of the solver can have a huge impact on parameter estimates in PDE models as well as ODE and DDE. There is no widespread convention on detection of this type of error and the conventional strategy would be to simply increase the solution accuracy (usually at significant computational cost) until the estimate stabilizes. Perhaps more importantly, the choice of the initial candidate parameter vector can have a huge impact upon the final estimate, given that nonlinear least squares cost functions frequently have multiple local minima in differential equations applications. There are several algorithms designed to deal with the multi-modality, such as particle swarm optimization and simulated annealing; however, all come at the cost of additional forward solves and unclear dependence on the hyperparameters used in the solver and optimization algorithms.

Given the above, it is reasonable to consider alternatives to fitting via comparing an approximate model solution with the measured data. A natural idea would be to avoid performing forward solves altogether via substituting the data directly into the model equation (2). The derivative could be approximated via differentiating a projection of the data onto, e.g., orthogonal polynomials, and the parameters could then be estimated by minimizing the norm of the residual of the equation (2)—i.e., via a gradient matching criterion. There have been similar ideas in the literature of chemical and aerospace engineering, which can be traced back even further. However, these methods are known to perform poorly in the presence of even modest noise.

To account for the noise in the measurements while estimating the parameters (and in some cases the state trajectories), researchers have proposed a variety of different non-solver-based methods. The most popular modern approaches involve denoising the measured state via Gaussian Processes and collocations projecting onto a polynomial or spline basis. For example, a Gaussian Process restricted to the manifold of solutions to an ODE may be used to infer both the parameters and the state using a Hamiltonian Markov chain Monte Carlo method. Similarly, a collocation-type method in which the solution is projected onto a spline basis may be considered. In a two-step procedure, both the basis weights and the unknown parameters are iteratively estimated. The minimization identifies the states and the parameters by penalizing poor faithfulness to the model equation (i.e., gradient matching) and deviations too far from the measured data. A similar strategy, based on local polynomial smoothing to first estimate the state and its derivative, compute derivatives of the smoothed solution, and then estimate the parameters may be considered. Improvements may be realized by using local polynomial regression instead of the pseudo-least squares estimator.

There are also a few approaches which focus on transforming the equations with operators that allow efficiently solving for the parameters. In particular, smoothing and derivative smoothing operators based on Fourier theory and Chebyshev operators may be considered. However, they have not proven to be as influential as the integral and weak form methods described in the next subsection.

### 1.2 Integral and Weak Form Methods

Recent efforts by our group and others suggest that there is a considerable advantage in parameter estimation performance to be gained from using an integral-based transform of the model equations. The two main approaches are to: (i) use integral forms of the model equation; or (ii) convolve the equation with a compactly supported test function to obtain the so-called “weak form” of the equation. The weak form idea can be traced back to Laurent Schwartz's Theory of Distributions, which recasts the classical notion of a function acting on a point to one acting on a measurement structure or “test function”. In the context of differential equation models, Lax and Milgram pioneered the use of the weak form for relaxing smoothness requirements on unique solutions to parabolic PDE systems in Hilbert spaces. Since then, the weak form has been heavily used in studying solutions to PDEs as well as numerically solving for the solutions (e.g., the Finite Element Method), but not with the goal of directly estimating parameters.

The idea of weak-form based estimation has been repeatedly discovered over the years. Briefly, in 1954, a proto-weak-form parameter inference method, called the Equations Of Motion (EOM) method was created. Using this method, it was proposed to multiply the model equations by so-called method functions, i.e., what would now be called test functions. These test functions were based on sinⁿ(vt) for different values of v and n. This method has alternatively been identified as the Modulating Function (MF) method. Both proposed and advocated for the use of polynomial test functions. The issue with these approaches (and indeed all subsequent developments based on these methods) is that the maximum power n is chosen to exactly match the number of derivatives needed to perform integration by parts (IBP). As now known, this choice means that these methods are not nearly as effective as they could be. As shown in the most preferred embodiments of the present invention, a critical step in obtaining robust and accurate parameter estimation is to use highly smooth test functions, e.g., to have n be substantially higher than the minimum needed by the IBP. This understanding led to the use of the Co bump functions in the most preferred embodiments of the present invention as disclosed herein (see Section 2.3).

In the relevant literature, there are several examples of using integral or weak-form equations that illustrate an integral-based approach in addition to efforts to use the integral form for parameter estimation. Concerning the weak form, several researchers have used it as a core part of their estimation methods. Unlike the most preferred embodiments of the present invention, however, either these approaches smooth the data before substitution into the model equation (which can lead to poor performance) or still require forward solves. As with the EOM and MF method described above, the test functions in these methods were also chosen with insufficient smoothness to yield the highly robust parameter estimates obtained from the most preferred embodiments of the present invention.

As the field of SINDy-based equation learning is built upon direct parameter estimation methods, there are also several relevant contributions from this literature. Previous efforts have shown that parameter estimation and learning an integral form of equations can be done in the presence of significant noise. Broadly speaking, however, the consensus has emerged that the weak form is more effective than a straightforward integral representation. In particular, several groups independently proposed weak form-based approaches. The weak form is now even implemented in the PySINDy code which is actively developed by the authors of the original SINDy papers. However, it should be noted that the Weak SINDy in PySINDy is based on an early weak form implementation.

While weak form methodology has been considered in the past, the most preferred embodiments of the present invention provide unique enhancements suitable for use for equation learning in a wide range of model structures and applications including: ODEs, PDEs, interacting particle systems of the first and second order, and online streaming. We have also studied and advanced the computational method itself. Among other contributions, we were the first to automate (with mathematical justification) test function hyperparameter specification, feature matrix rescaling (to ensure stable computations), and to filter high frequency noise [34]. Lastly we have also studied the theoretical convergence properties for WSINDy in the continuum data limit [36]. Among the results are a description of a broad class of models for which the asymptotic limit of continuum data can overcome any noise level to yield both an accurately learned equation and a correct parameter estimate (see for more information).

### 2.0 Weak form Estimation of Nonlinear Dynamics (WENDy)

In this work, we assume that the exact form of a differential equation-based mathematical model is known, but that the precise values of constituent parameters are to be estimated using existing data. As the model equation is not being learned, this is different than the WSINDy methodology and, importantly, does not use sparse regression. We thus denote the method presented in this paper as the Weak-form Estimation of Nonlinear Dynamics (WENDy) method.

In Section 2.1, we start with an introduction to the idea of weak-form parameter estimation in a simple OLS setting. In Section 2.2 we describe the WENDy algorithm in detail, along with several strategies for improving the accuracy: in Section 2.3 we describe a strategy for optimal test function selection, and in Section 2.4 the strategy for improved iteration termination criteria.

### 2.1 Weak-Form Estimation with Ordinary Least Squares

We begin by considering a d-dimensional matrix form of (2), i.e., an ordinary differential equation system model

$${u}^{\cdot } = Θ ( u ) W \qquad ( 3 )$$

with row vector of the d solution states u(t;W):=[u₁(t;W)|u₂(t;W)| . . . |u_{d}(t;W)], row vector of J features (i.e., right side terms) Θ(u):=[ƒ₁(u)|ƒ₂(u)| . . . |ƒ_{J}(u)] where ƒⱼ:R^{d}→R, and the matrix of unknown parameters W∈R^{J×d}. We consider a C^{∞} test function ϕ compactly supported in the time interval [0,T] (e.g. ϕ∈C_{c}^{∞}([0,T])), multiply both sides of (3) by ϕ, and integrate over 0 to T. Via integration by parts we obtain

$$ϕ ( T ) u ( T ) - ϕ ( 0 ) u ( 0 ) - {\int }_{0}^{T} {ϕ}^{\cdot } u dt = {\int }_{0}^{T} ϕΘ ( u ) W dt .$$

As the compact support of ϕ implies that ϕ(0)=ϕ(T)=0, this yields a transform of (3) into

$$- {\int }_{0}^{T} {ϕ}^{\cdot } udt = {\int }_{0}^{T} ϕΘ ( u ) Wdt . \qquad ( 4 )$$

This weak form of the equation allows us to define a novel methodology for estimating the entries in W.

Observations of states of this system are (in this paper) assumed to occur at a discrete set of M+1 timepoints {tₘ}ₘ₌₀^{M} with uniform stepsize Δt. The test functions are thus centered at a subsequence of K timepoints {tₘ_{ₖ}}ₖ₌₁^{K}. We choose the test function support to be centered at a timepoint tₘ_{ₖ} with radius mₜΔt where mₜ is an integer (to be chosen later). Bold variables denote evaluation at or dependence on the chosen timepoints, e.g.,

$$t := [ \begin{matrix}{t}_{0} & ⋮ & {t}_{M}\end{matrix} ] , u := [ \begin{matrix}{u}_{1} ( {t}_{0} ) & … & {u}_{d} ( {t}_{0} ) & ⋮⋱⋮ & {u}_{1} ( {t}_{M} ) & … & {u}_{d} ( {t}_{M} )\end{matrix} ] , \\ Θ ( u ) := [ \begin{matrix}{f}_{1} ( u ( {t}_{0} ) ) & … & {f}_{J} ( u ( {t}_{0} ) ) & ⋮⋱⋮ & {f}_{1} ( u ( {t}_{M} ) ) & … & {f}_{J} ( u ( {t}_{M} ) )\end{matrix} ]$$

Approximating the integrals in (4) using a Newton-Cotes quadrature yields

$$- {{ϕ}^{\cdot }}_{k} u \approx {Φ}_{k} Θ ( u ) W \qquad ( 5 )$$

Where

$${Φ}_{k} := [ {ϕ}_{k} ( {t}_{0} ) \vert … \vert {ϕ}_{k} ( {t}_{M} ) ] Q , {{Φ}^{\cdot }}_{k} := [ {{ϕ}^{\cdot }}_{k} ( {t}_{0} ) \vert … \vert {{ϕ}^{\cdot }}_{k} ( {t}_{M} ) ] Q$$

and ϕₖ is a test function centered at timepoint tₘ_{ₖ}. To account for proper scaling, in computations we normalize each test function ϕₖ to have unit l₂-norm, or τₘ₌₀^{M}ϕₖ²(tₘ)=1.

The Q matrix contains the quadrature weights on the diagonal. In this work we use the composite Trapezoidal rule 3 for which the matrix is

$$Q := ( \frac{Δ t}{2} , Δ t , ... , Δ t , \frac{Δ t}{2} ) ∈ {R}^{( M + 1 ) \times ( M + 1 )}$$

We defer full consideration of the integration error until Section 2.3 but note that in the case of a non-uniform timegrid, Q would simply be adapted with the correct stepsize and quadrature weights.

The core idea of the weak-form-based direct parameter estimation is to identify W as a least squares solution to

$${min}_{W} {‖ ( GW - B ) ‖}_{2}^{2} \qquad ( 6 )$$

where “vec” vectorizes a matrix,

$$G := ΦΘ ( U ) ∈ {R}^{K \times J} B := - {Φ}^{\cdot } U ∈ {R}^{K \times d}$$

where U represents the data, and the integration matrices are

$$Φ = [ \begin{matrix}{Φ}_{1} & ⋮ & {Φ}_{K}\end{matrix} ] ∈ {R}^{K \times ( M + 1 )} and {Φ}^{\cdot } = [ \begin{matrix}{{Φ}^{\cdot }}_{1} & ⋮ & {{Φ}^{\cdot }}_{K}\end{matrix} ] ∈ {R}^{K \times ( M + 1 )}$$

The ordinary least squares (OLS) solution to (6) is presented in Algorithm 1. We note that we have written the algorithm this way to promote clarity concerning the weak-form estimation idea. For actual implementation, we create a different Θᵢ for each variable i=1 . . . , d and use regression for state i to solve for a vector ŵᵢ of parameters (instead of a matrix of parameters W, which can contain values known to be zero). To increase computational efficiency, it is important to remove any redundancies and use sparse computations whenever possible.

Algorithm 1: Weak-form Parameter Estimation
with Ordinary Least Squares

```
  input : Data {U}, Feature Map {Θ}, Test Function Matrices {Φ, \dot{Φ}}
  output: Parameter Estimate {Ŵ}
  // Solve Ordinary Least Squares Problem
1 G ← ΦΘ(U)
2 B ← −\dot{Φ}U
3 Ŵ ← (G^{T}G)⁻¹G^{T}B
```

The OLS solution has respectable performance in some cases, but in general there is a clear need for improvement upon OLS. In particular, it should be noted that (6) is not a standard least squares problem. The (likely noisy) observations of the state u appear on both sides of (5). Those skilled in the art will recognize this as an Errors in Variables (EiV) problem. While a full and rigorous analysis of the statistical properties of weak-form estimation is beyond the scope of this disclosure, several formal derivations aimed at improving the accuracy of parameter estimation are presented. These improvements are critical as the OLS approach is not generally considered to be reliably accurate. Accordingly, we define WENDy (in the next section) as a weak-form parameter estimation method which uses techniques that address the EiV challenges.

### 2.2 WENDy: Weak-Form Estimation Using Iterative Reweighting

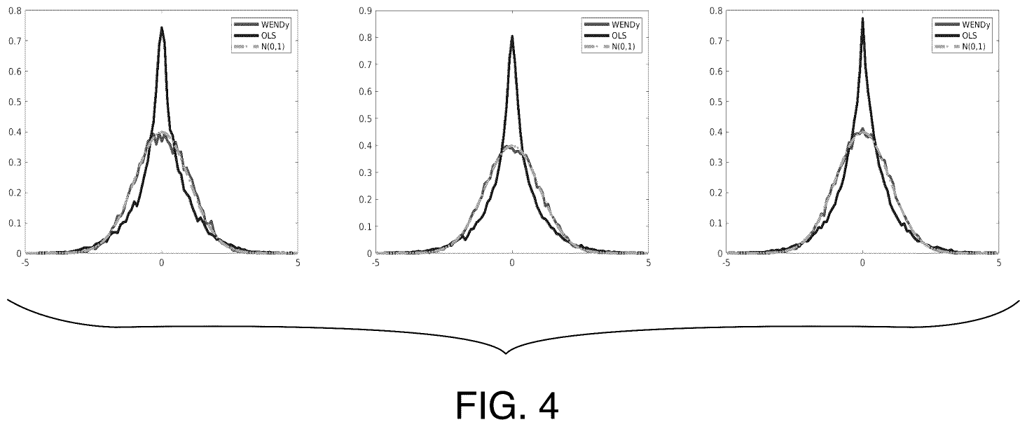

In this subsection, it should be acknowledged that the regression problem does not fit within the framework of ordinary least squares (see FIG. 4) and is actually an Errors-In-Variables problem. A linearization can be derived that yields insight into the covariance structure of the problem. First, we denote the vector of true (but unknown) parameter values used in all state variable equations as w* and let u*:=u(t;w*) and Θ*:=Θ(u*). We also assume that measurements of the system are noisy, so that at each timepoint t all states are observed with additive noise

$$U ( t ) = {u}^{★} ( t ) + ε ( t ) \qquad ( 7 )$$

where each element of ε(t) is i.i.d. N(0,σ²). Lastly, it should be noted that there are d variables, J feature terms, and M+1 timepoints. In what follows, an expansion using Kronecker products (denoted ⊗) is presented.

Begin with the sampled data U:=u*+ε∈R^{(M+1)×d} and vector of parameters to be identified w∈R^{Jd}. Use bolded variables to represent evaluation at the timegrid t, and use superscript * notation to denote quantities based on true (noise-free) parameter or states. The residual becomes

$$r ( U , w ) := Gw - b \qquad ( 8 )$$

where G and b are redefined

$$G := [ {I}_{d} ⊗ ( ΦΘ ( U ) ) ] , b := - ( {Φ}^{\cdot } U ) .$$

It is now possible to decompose the residual into several components

$$r ( U , w ) = Gw - {G}^{★} w + {G}^{★} w - {G}^{★} {w}^{★} + {G}^{★} {w}^{★} - ( {b}^{★} + {b}^{ε} ) = ( G - {G}^{★} ) {w}_{︸ {e}_{Θ}} + {{G}^{★} ( w - {w}^{★} )}_{︸ {r}_{0}} + {( {G}^{★} {w}^{★} - {b}^{★} )}_{︸ {e}_{int}} - {b}^{ε} ,$$

Where

$${G}^{★} := [ {I}_{d} ⊗ ( ΦΘ ( {u}^{★} ) ) ] b := - {( {Φ}^{\cdot } {u}^{★} )}_{︸ {b}^{★}} + - ( {Φ}^{\cdot } ε ) {.}_{︸ {b}^{ε}}$$

Here, r₀ is the residual without measurement noise or integration errors, and eᵢₙₜ is the numerical integration error induced by the quadrature (and will be analyzed in Section 2.3).

Further considering the leftover terms e_{Θ}−b^{ε} and taking a Taylor expansion around the data U

$${e}_{Θ} - {b}^{ε} = ( G - {G}^{★} ) w + vec ( {Φ}^{\cdot } ε ) = [ {I}_{d} ⊗ ( Φ ( Θ ( U ) - Θ ( U - ε ) ) ] w + [ {I}_{d} ⊗ {Φ}^{\cdot } ] vec ( ε ) = {L}_{w} vec ( ε ) + h ( U , w , ε ) \qquad ( 9 )$$

where h(U,w,ε) is a vector-valued function of higher order terms in the measurement errors & (including the Hessian as well as higher order derivatives). It should be noted that the h function will generally produce a bias and higher-order dependencies for all system where ∇²Θ≠0, but vanishes when ε=0.

The first order matrix in the expansion (9) is

$${L}_{w} := [ mat {( w )}^{T} ⊗ Φ ] ∇ Θ P + [ {I}_{d} ⊗ {Φ}^{\cdot } ]$$

where “mat” is the matricization operation and P is a permutation matrix such that Pvec(ε)=vec(ε^{T}). The matrix ∇Θ contains derivatives of the features

$$∇ Θ := [ ∇ {f}_{1} ( {U}_{0} ) ⋱ ∇ {f}_{1} ( {U}_{M} ) ⋮ ∇ {f}_{J} ( {U}_{0} ) ⋱ ∇ {f}_{J} ( {U}_{M} ) ] ,$$

$$where ∇ {f}_{j} ( {U}_{m} ) = [ \frac{\partial }{\partial {u}_{1}} {f}_{j} ( {U}_{m} ) \vert … \vert \frac{\partial }{\partial {u}_{d}} {f}_{j} ( {U}_{m} ) ]$$

and Uₘ is the row vector of true solution states at tₘ.

As mentioned above, it is assumed that all elements of ε are i.i.d. Gaussian, i.e., N(0,σ²) and thus to first order the residual is characterized by

$$G w - b - ( {r}_{0} + {e}_{int} ) ∼ N ( 0 , {σ}^{2} {{L}_{w} ( {L}_{w} )}^{T} ) \qquad ( 10 )$$

In the case where w=w* and the integration error is negligible, (10) simplifies

$$G {w}^{⋆} - b ∼ N ( 0 , {σ}^{2} {{L}_{{w}^{⋆}} ( {L}_{{w}^{⋆}} )}^{T} ) \qquad ( 11 )$$

It should be noted that in (11) (and in (10)), the covariance is dependent upon the parameter vector w. In the statistical inference literature, the Iteratively Reweighted Least Squares (IRLS) method offers a strategy to account for a parameter-dependent covariance by iterating between solving for w and updating the covariance matrix C. Furthermore, while the normality in (11) is approximate, the weighted least squares estimator has been shown to be consistent under fairly general conditions even without normality. In Algorithm 2 the WENDy method is presented, updating C⁽ⁿ⁾ (at the n-th iteration step) in lines 7-8 and then the new parameters w⁽ⁿ⁺¹⁾ are computed in line 9 by weighted least squares.

The IRLS step in line 9 requires inverting C⁽ⁿ⁾, which is done by computing its Cholesky factorization and then applying the inverse to G and b. Since this inversion may be unstable, it is desirable to allow for possible regularization of C⁽ⁿ⁾ in line 8 via a convex combination between the analytical first-order covariance L⁽ⁿ⁾(L⁽ⁿ⁾)^{T} and the identity via the covariance relaxation parameter a. This regularization allows the user to interpolate between the OLS solution (α=1) and the unregularized IRLS solution (α=0). In this way WENDy extends and encapsulates Algorithm 1. However, in the numerical examples below, it is possible to simply set α=10⁻¹⁰ throughout, as the aforementioned instability was not an issue. Lastly, those skilled in the art will recognize that any iterative scheme needs a stopping criteria and this is further discussed in Section 2.4.

Algorithm 2: WENDy

| | input : Data {U}, Feature Map {Θ, ∇Θ}, Test Function Matrices {Φ, \dot{Φ}}, Stopping Criteria {SC}, |
|---|---|
| | Covariance Relaxation Parameter {α}, Variance Filter {f} |
| | output: Parameter Estimate {ŵ, Ĉ, \hat{σ}, S, stdx} |
| | // Compute weak-form linear system |
| 1 | G ← [ [symbol] ⊗ (ΦΘ(U))] |
| 2 | b ← −vec(\dot{Φ}U) |
| | // Solve Ordinary Least Squares Problem |
| 3 | w⁽⁰⁾ ← (G^{T}G)⁻¹G^{T}b |
| | // Solve Iteratively Reweighted Least Squares Problem |
| 4 | n ← 0 |
| 5 | check ← true |
| 6 | while check is true do |
| 7 | \| L⁽ⁿ⁾ ← [mat(w⁽ⁿ⁾)^{T} ⊗ Φ]∇Θ(U)P + [ [symbol] ⊗ \dot{Φ}] |
| 8 | \| C⁽ⁿ⁾ = (1 − α)L⁽ⁿ⁾(L⁽ⁿ⁾)^{T} + αI |
| 9 | \| w⁽ⁿ⁺¹⁾ ← (G^{T}(C⁽ⁿ⁾)⁻¹G)⁻¹G^{T}(C⁽ⁿ⁾)⁻¹b |
| 10 | \| check ← SC(w⁽ⁿ⁺¹⁾, w⁽ⁿ⁾) |
| 11 | \| n ← n + 1 |
| 12 | end |
| | // Return estimate and standard statistical quantities |
| 13 | ŵ ← w⁽ⁿ⁾ |
| 14 | Ĉ ← C⁽ⁿ⁾ |
| 15 | \hat{σ} ← (Md)^{-1/2} \|\|f * U\|\|_{F} |
| 16 | S ← \hat{σ}²((G^{T}G)⁻¹G^{T}) Ĉ (G(G^{T}G)⁻¹)) |
| 17 | stdx ← \sqrt{diag(S)} |

The outputs of Algorithm 2 include the estimated parameters ŵ as well as the covariance Ĉ of the response vector b such that approximately

$$b ∼ N ( G \hat{w} , {σ}^{2} \hat{C} )$$

A primary benefit of the most preferred embodiments of the present methodology disclosed herein is that the parameter covariance matrix S can be estimated from Ĉ using

$$S := {\hat{σ}}^{2} ( {( {G}^{T} G )}^{- 1} {G}^{T} ) \hat{C} ( {G ( {G}^{T} G )}^{- 1} ) ) \qquad ( 12 )$$

This yields the variances of individual components of ŵalong diag (S) as well as the correlations between elements of ŵ in the off-diagonals of S. Here \hat{σ}² is an estimate of the measurement variance σ², which we compute by convolving each compartment of the data U with a high-order⁷ filter ƒ and taking the Frobenius norm of the resulting convolved data matrix ƒ*U. Throughout ƒ is set to be the centered finite difference weights of order 6 over 15 equally-spaced points (computed using [17]), so that ƒ has order 5. The filter ƒ is then normalized to have unit 2-norm. This yields a high-accuracy approximation of σ² for underlying data u* that is locally well-approximated by polynomials up to degree 5.

### 2.3 Choice of Test Functions

When using WENDy for parameter estimation, a valid question concerns the choice of test function. This may be particularly challenging in the sparse data regime, where integration errors can easily affect parameter estimates. As previously noted, using higher order polynomials as test functions yielded more accuracy (up to machine precision). Inspired by this result and to render moot the question of what order polynomial is needed, it is considered desirable to develop a 2-step process for offline computation of highly efficient test functions, given a timegrid t.

The first step is to derive an estimator of the integration error that can be computed using the noisy data U and used to detect a minimal radius mₜ such that mₜ>mₜ leads to negligible integration error compared to the errors introduced by random noise. Inspired by wavelet decompositions; next, row-concatenate convolution matrices of test functions at different radii mₜ:=(2^{k}mₜ; l={0, . . . , l⁻}). An SVD of this tall matrix yields an orthonormal test function matrix Φ, which maximally extracts information across different scales. It should be noted that in the later examples l⁻=3, which in many cases leads to a largest test function support covering half of the time domain.

To begin, consider a C^{∞} bump function

$$ψ ( t ; a ) = ( - \frac{η}{{[ 1 - {( t / a )}^{2} ]}_{+}} ) \qquad ( 13 )$$

where the constant C enforces that ∥ψ∥₂=1, η is a shape parameter, and [⋅]₊:=max(⋅,0), so that ψ(t;a) is supported only on [−a,a] where

$$a = {m}_{t} Δ t . \qquad ( 14 )$$

With the ψ in (13) we have discovered that the accuracy of the parameter estimates is relatively insensitive to a wide range of η values. Therefore, based on empirical investigation we arbitrarily choose η=9 in all examples and defer more extensive analysis to future work. In the rest of this section, we will describe the computation of mₜ and how to use ψ to construct Φ and Φ^{⋅}.

### Minimum Radius Selection

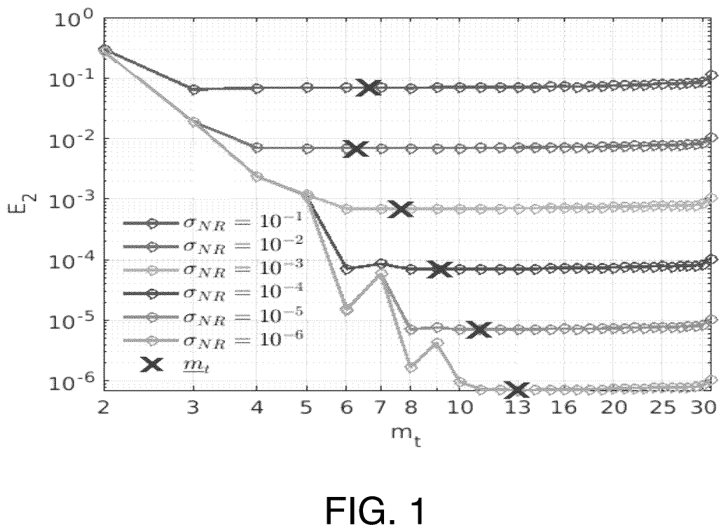

In (9), it is clear that reducing the numerical integration errors eᵢₙₜ will improve the estimate accuracy. FIG. 1 illustrates for the Logistic Growth model how the relative error changes as a function of test function radius mₜ (for different noise levels). As the radius increases, the error become dominated by the measurement noise. To establish a lower bound mₜ on the test function radius mₜ, an estimate is created for the integration error which works for any of the d variables in a model. To promote clarity, let u be any of the d variables for the remainder of this section. However, it is important to note the final êᵣₘₛ sums over all d variables.

Considering the k-th element of

$${e}_{int} {{e}_{int} ( {u}^{*} , {ϕ}_{k} , M )}_{k} = {( {G}^{*} {w}^{*} - {b}^{*} )}_{k} = {\sum }_{m = 0}^{M - 1}$$

$$( {ϕ}_{k} ( {t}_{m} ) {u}_{m}^{\cdot *} + {ϕ}_{k}^{\cdot } ( {t}_{m} ) {u}_{m}^{*} ) Δ t = \frac{T}{M} {\sum }_{m = 0}^{M - 1} \frac{d}{dt} ( {ϕ}_{k} ( {t}_{m} ) {u}_{m}^{*} )$$

where Δt=T/M for a uniform timegrid t=(0, Δt, 2Δt, . . . , MΔt) with overall length T. We also note that the biggest benefit of this approach is that eᵢₙₜ does not explicitly depend upon w*.

By expanding

$$\frac{d}{dt} ( {ϕ}_{k} ( t ) {u}^{*} ( t ) )$$

into its Fourier Series we then have

$${e}_{int} ( {u}^{*} , {ϕ}_{k} , M ) = \frac{T}{M \sqrt{T}} {\sum }_{n ∈ Z} {F}_{n} [ \frac{d}{dt} ( {ϕ}_{k} ( t ) {u}^{*} ( t ) ) ] ( {\sum }_{m = 0}^{M - 1} {e}^{\frac{2 π i nm}{M}} ) = \frac{2 π i}{\sqrt{T}} {\sum }_{n ∈ Z} {nMF}_{nM} [ {ϕ}_{k} {u}^{*} ] , \qquad ( 15 )$$

Referring now to FIG. 1, it should be noted that coefficient error E₂=∥w*−ŵ∥₂/∥w*∥₂ of WENDy applied to the Logistic Growth model vs test function radius mₜ for noise levels σ_{NR}∈{10⁻⁶, . . . , 10⁻¹}. For large enough radius, errors are dominated by noise and integration error is negligible. The minimum radius mₜ computed as in Section 2.3 finds this noise-dominated region, which varies depending on σ_{NR}.
so that the integration error is entirely represented by aliased modes {M, 2M, . . . } of ϕₖu*. Assuming [−a+tₖ,a+tₖ]⊂[0,T] and T>2a>1, we have the relation

$${F}_{n} [ {ϕ}_{k} ( \cdot ; a ) ] = {aF}_{na} [ {ϕ}_{k} ( \cdot ; 1 ) ]$$

hence increasing a corresponds to higher-order Fourier coefficients of Φₖ(⋅;1) entering the error formula (15), which shows, using (15), that increasing a (eventually) lowers the integration error. For small mₜ, this leads to the integration error eᵢₙₜ dominating the noise-related errors, while for large mₜ, eᵢₙₜ noise-related effects are dominant.

It is now possible to derive a surrogate approximation of eᵢₙₜ using the noisy data U to estimate this transition from integration error-dominated to noise error-dominated residuals. From the noisy data U on timegrid t∈R^{M}, it is desirable to compute eᵢₙₜ (u*,ϕₖ,M) by substituting U for u* and using the discrete Fourier transform (DFT), however the highest accessible mode is \hat{F}_{±M/2}[ϕU]. On the other hand, it is possible to approximate eᵢₙₜ (u*,ϕₖ,└M/s┘) from U, that is, the integration error over a coarsened timegrid (0, [symbol] , 2 [symbol] , . . . , └M/s┘ [symbol] ), where [symbol] =T/└M/s┘ and s>2 is a chosen coarsening factor. By introducing the truncated error formula

$${\hat{e}}_{int} ( {u}^{*} , {ϕ}_{k} , ⌊ \frac{M}{s} ⌋ , s ) := \frac{2 π i}{\sqrt{T}} {\sum }_{n = - ⌊ \frac{s}{2} ⌋}^{⌊ \frac{s}{2} ⌋} n ⌊ \frac{M}{s} ⌋ {F}_{n ⌊ \frac{M}{s} ⌋} [ {ϕ}_{k} {u}^{*} ]$$

The result is

$${\hat{e}}_{int} ( {u}^{*} , {ϕ}_{k} , ⌊ M / s ⌋ , s ) \approx {e}_{int} ( {u}^{*} , {ϕ}_{k} , ⌊ M / s ⌋ ) ,$$

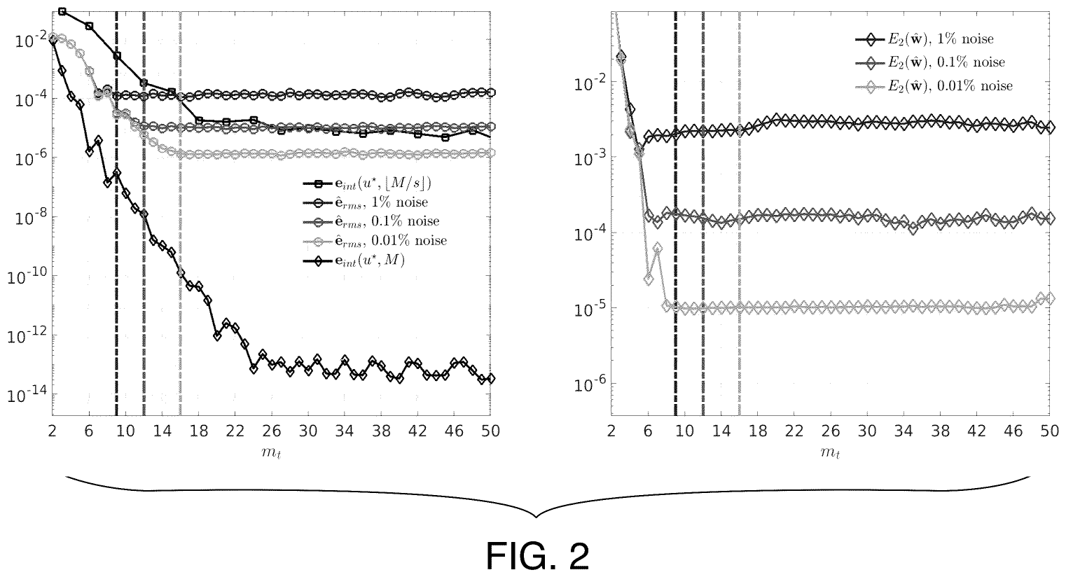

and êᵢₙₜ can be directly evaluated at U using the DFT. In particular, with 2<s<4, the result is

$${\hat{e}}_{int} ( U , {ϕ}_{k} , ⌊ \frac{M}{s} ⌋ , s ) = \frac{2 π i ⌊ \frac{M}{s} ⌋}{\sqrt{T}} ( {\hat{F}}_{⌊ \frac{M}{s} ⌋} [ {ϕ}_{k} U ] - {\hat{F}}_{- ⌊ \frac{M}{s} ⌋} [ {ϕ}_{k} U ] ) = - \frac{4 π ⌊ \frac{M}{s} ⌋}{\sqrt{T}} \{ {\hat{F}}_{⌊ \frac{M}{s} ⌋} [ {ϕ}_{k} U ] \}$$

where Im {z} denotes the imaginary portion of z∈C, so that only a single Fourier mode needs computation. In most practical cases of interest, this leads to (see FIG. 2)

$${e}_{int} ( {u}^{*} , {ϕ}_{k} , M ) \leq {\hat{e}}_{int} ( U , {ϕ}_{k} , ⌊ M / s ⌋ , s ) \leq {e}_{int} ( {u}^{*} , {ϕ}_{k} , ⌊ M / s ⌋ ) \qquad ( 16 )$$

ensuring that êint (U,ϕₖ,└M/s┘,s) is below some tolerance τ leads also to eᵢₙₜ (u,ϕₖ,M)<τ.

Statistically, under this additive noise model, êᵢₙₜ (U,ϕₖ,└M/s┘,s) is an unbiased estimator of êᵢₙₜ (u*,ϕₖ,└M/s┘,s), i.e.,

$$E [ {\hat{e}}_{int} ( U , {ϕ}_{k} , ⌊ \frac{M}{s} ⌋ , s ) ] = E [ - ( \frac{4 π ⌊ \frac{M}{s} ⌋}{\sqrt{T}} ) \{ {\hat{F}}_{⌊ \frac{M}{s} ⌋} [ {ϕ}_{k} ( {u}^{★} + ε ) ] \} ] = E [ {\hat{e}}_{int} ( {u}^{★} , {ϕ}_{k} ⌊ \frac{M}{s} ⌋ , s ) ]$$

where E denotes expectation. The variance satisfies, for 2<s<4,

$$[ {\hat{e}}_{int} ( U , {ϕ}_{k} , ⌊ \frac{M}{s} ⌋ , s ) ] := {{σ}^{2} ( \frac{4 π ⌊ \frac{M}{s} ⌋}{M} )}^{2} {\sum }_{j = 1}^{M - 1} {ϕ}_{k}^{2} ( j Δ t ) ( \frac{2 π ⌊ \frac{M}{s} ⌋ j}{M} ) \leq {{σ}^{2} ( \frac{4 π ⌊ \frac{M}{s} ⌋}{M} )}^{2}$$

where σ₂=Var [ϵ]. The upper bound follows from ∥ϕₖ∥₂=1, and shows that the variance is not sensitive to the radius of the test function ϕₖ.

Picking radius mₜ as a changepoint of log(êᵣₘₛ), where êᵣₘₛ is the root-mean-squared integration error over test functions placed along the timeseries,

$${\hat{e}}_{rms} ( {m}_{t} ) := {K}^{- 1} {\sum }_{k = 1}^{K} {\sum }_{i = 1}^{d} {{\hat{e}}_{int} ( {U}^{( i )} , {ϕ}_{k} ( \cdot ; {m}_{t} ) , ⌊ \frac{M}{s} ⌋ , s )}^{2} \qquad ( 17 )$$

where U⁽ⁱ⁾ is the i th variable in the system. FIG. 2 depicts êᵣₘₛ as a function of support radius mₜ. As can be seen, since the variance of êᵢₙₜ is insensitive to the radius mₜ, the estimator is approximately flat over the region with negligible integration error, a perfect setting for changepoint detection. Crucially, in practice and as shown in FIG. 2, the minimum radius \vec{mₜ} lies to the right of the changepoint of the coefficient errors

$${E}_{2} ( \hat{w} ) := \frac{{‖ \hat{w} - {w}^{★} ‖}_{2}^{2}}{{‖ {w}^{★} ‖}_{2}^{2}}$$

as a function of mₜ. Lastly, note that the red x in FIG. 1 depicts the identified mₜ for the Logistic Growth model.

### Orthonormal Test Functions

Having computed the minimal radius mₜ, it is possible to construct the test function matrices (Φ,Φ^{⋅}) by orthonormalizing and truncating a concatenation of test function matrices with mₜ:=mₜ×(1,2,4,8). Letting Ψₗ be the convolution matrix for ψ(⋅;2^{l}mₜΔt), we compute the SVD of

$$Ψ := [ {Ψ}_{0} {Ψ}_{1} {Ψ}_{2} {Ψ}_{3} ] = Q \sum {V}^{T}$$

Referring now to FIG. 2, a visualization of the minimum radius selection using single realizations of Fitzhugh-Nagumo data with 512 timepoints at three different noise levels is depicted. Dashed lines indicate the minimum radius mₜ Left: we see that inequality (16) holds empirically for small radii mₜ. Right: coefficient error E₂ as a function of mₜ is plotted, showing that for each noise level the identified radius mₜ using êᵣₘₛ lies to right of the dip in E₂, as random errors begin to dominate integration errors. In particular, for low levels of noise, mₜ increases to ensure high accuracy integration.

The right singular vectors V then form an orthonormal basis for the set of test functions forming the rows of Ψ. Letting r be the rank of Ψ, we then truncate the SVD to rank K, where K is selected as the changepoint in the cumulative sum of the singular values (Σᵢᵢ)ᵢ₌₁^{r}. Let

$$Φ = {( {V}^{( K )} )}^{T}$$

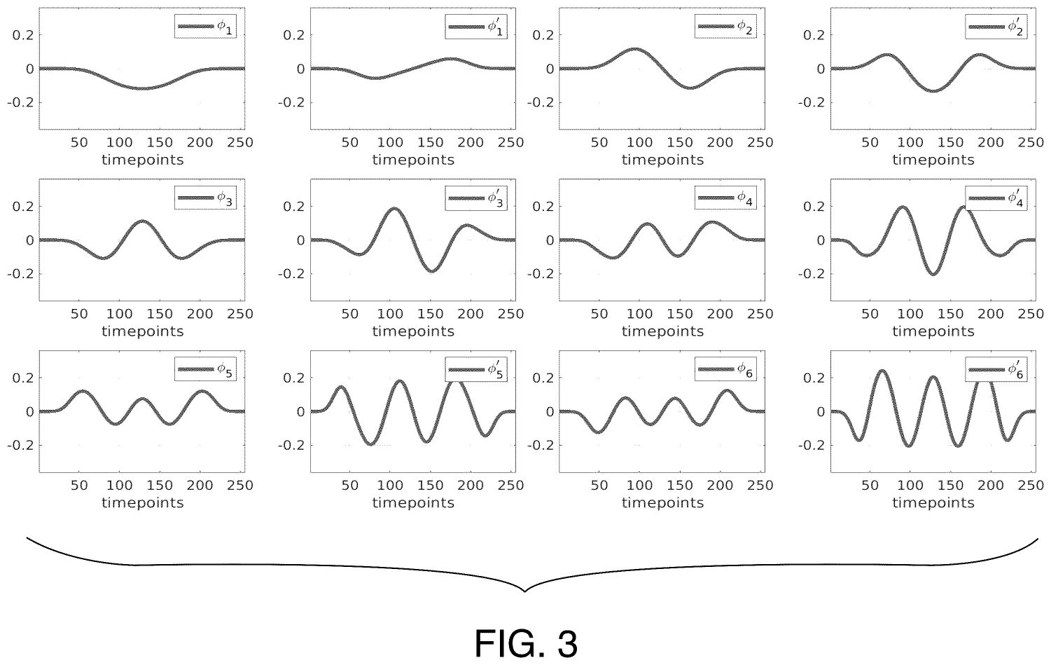

be the test function basis where V^{(K)} indicates the first K modes of V. Unlike previous implementations, the derivative matrix Φ^{⋅} must now be computed numerically, however given the compact support and smoothness of the reference test functions ψ(⋅;2^{l}mₜΔt), this can be done very accurately with Fourier differentiation. Hence, let

$${Φ}^{\cdot } = {F}^{- 1} ( ik ) F Φ$$

where F is the discrete Fourier transform and k are the requisite wavenumbers. FIG. 3 displays the first six orthonormal test functions along with their derivatives obtained from this process applied to Hindmarsh-Rose data.

### 2.4 Stopping Criteria

Having formed the test function matrices {Φ,Φ^{⋅}}, the remaining unspecified process in Algorithm 2 is the stopping criteria SC. The iteration can stop in one of three ways: (1) the iterates reach a fixed point, (2) the number of iterates exceeds a specified limit, or (3) the residuals

$${r}^{( n + 1 )} := {( {C}^{( n )} )}^{- \frac{1}{2}} ( {Gw}^{( n + 1 )} - b )$$

are no longer approximately normally distributed. (1) and (2) are straightforward limitations of any iterative algorithm while (3) results from the fact that the weighted least-squares framework is only approximate. In ideal scenarios where the discrepancy terms eᵢₙₜ and h(u*,w*;ε) are negligible, equation (10) implies that

$${( {C}^{★} )}^{- 1} ( {Gw}^{★} - b ) ∼ N ( 0 , {σ}^{2} I )$$

Referring now to FIG. 3, the first six orthonormal test functions obtained from Hindmarsh-Rose data with 2% noise and 256 timepoints using the process outlined in Section 2.3 are depicted.
where C*=L*(L*)^{T} is the covariance computed from w*. Hence it is expected that r⁽ⁿ⁾ will agree with a normal distribution more strongly as n increases. If the discrepancy terms are non-negligible, it is possible that the reweighting procedure will not result in an increasingly normal r⁽ⁿ⁾, and iterates w⁽ⁿ⁾ may become worse approximations of w*. A simple way to detect this is with the Shapiro-Wilk (S−W) test for normality, which produces an approximate p-value under the null hypothesis that the given sample is i.i.d. normally distributed. However, the first few iterations are also not expected to yield i.i.d. normal residuals (see FIG. 4), so the S−W test is only checked after a fixed number of iterations no. Letting SW⁽ⁿ⁾:=SW(r⁽ⁿ⁾) denote the p-value of the S−W test at iteration n>n₀, and setting SW⁽ⁿ^{₀}⁾=1, the stopping criteria may be specified as:

$$SC ( {w}^{( n + 1 )} , {w}^{( n )} ) = \{ \frac{{‖ {w}^{( n + 1 )} - {w}^{( n )} ‖}_{2}}{{‖ {w}^{( n )} ‖}_{2}} > {τ}_{FP} \} and \{ n \} and \{ {SW}^{( max \{ n , {n}_{0} \} )} > {τ}_{SW} \} \qquad ( 18 )$$

With the fixed-point tolerance set to τ_{FP}=10⁻⁶, the S−W tolerance and starting point to τ_{SW}=10⁻⁴ and n₀=10, and max_its=100.

### 3. Illustrating Examples

The effectiveness of the most preferred embodiments of the present invention can be demonstrated by applying the methods to five ordinary differential equations canonical to biology and biochemical modeling. As demonstrated in the works mentioned in Section 1, it is known that the weak or integral formulations are advantageous, with previous works mostly advocating for a two-step process involving (i) pre-smoothing the data before (ii) solving for parameters using ordinary least squares. The most preferred embodiments of the present invention do not necessarily involve smoothing the data, and instead leverages the covariance structure introduced by the weak form to iteratively reduce errors in the ordinary least squares (OLS) weak-form estimation. Utilizing the covariance structure in this way not only reduces error, but reveals parameter uncertainties as demonstrated in Section 3.3.

Referring now to FIG. 4, Histograms of the WENDy (red) and OLS (blue) residuals are evaluated at the WENDy output ŵ applied to the (left-right) Logistic Growth, Lotka-Volterra, and Fitzhugh-Nagumo data, each with 256 timepoints and 20% noise. Curves are averaged over 100 independent trials with each histogram scaled by its empirical standard deviation. In each case, the WENDy residual agrees well with a standard normal, while the OLS residual exhibits distinctly non-Gaussian features, indicative that OLS is the wrong statistical regression model.

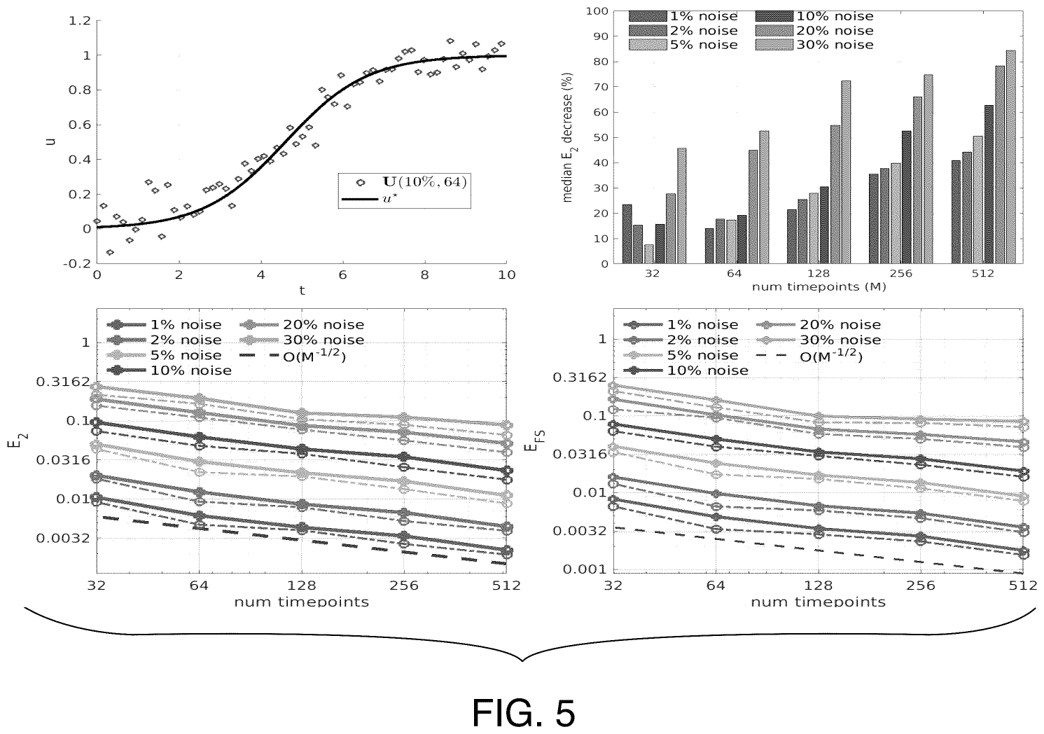

We compare the WENDy solution to the weak-form ordinary least squares solution (described in Section 2 and denoted simply by OLS in this section) to forward solver-based nonlinear least squares (FSNLS). Comparison to OLS is important due to the growing use of weak formulations in joint equation learning/parameter estimation tasks, but often without smoothing or further variance reduction steps. In most cases WENDy reduces the OLS error by 60%-90% (see the bar plots in FIGS. 5-9). When compared to FSNLS, the most preferred embodiments of the present invention provide a more efficient and accurate solution in typical use cases; however, in the regime of highly sparse data and large noise, FSNLS provides an improvement in accuracy at a higher computational cost. Furthermore, it can be demonstrated that FSNLS may be improved by using the methods of the present invention to output an initial guess.

### 3.1 Numerical Methods and Performance Metrics

In all cases below, it is possible to solve for approximate weights ŵ using Algorithm 2 over 100 independent trials of additive Gaussian noise with standard deviation σ=σ_{NR}∥vec (U*)∥ᵣₘₛ for a range of noise ratios σ_{NR}. This specification of the variance implies that

$${σ}_{NR} \approx \frac{{‖ ( {U}^{★} - U ) ‖}_{rms}}{{‖ ( U ) ‖}_{rms}}$$

so that σ_{NR} can be interpreted as the relative error between the true and noisy data. Results from all trials are aggregated by computing the mean and median. Computations of Algorithm 2 are performed in MATLAB on a laptop with 40 GB of RAM and an 8-core AMD Ryzen 7 pro 4750u processor. Computations of FSNLS are also performed in MATLAB but were run on the University of Colorado Boulder's Blanca Condo Cluster in a trivially parallel manner over a homogeneous CPU set each with Intel Xeon Gold 6130 processors and 24 GB RAM. Due to the comparable speed of the two processors (1.7 GHz for AMD Ryzen 7, 2.1 GHz for Intel Xeon Gold) and the fact that each task required less than 5 GB working memory (well below the maximum allowable), it may be postulated that the walltime comparisons between WENDy and FSNLS below are fair.

As well as σ_{NR}, we vary the stepsize Δt (keeping the final time T fixed for each example), to demonstrate large and small sample behavior. For each example, a high-fidelity solution is obtained on a fine grid (512 timepoints for Logistic Growth, 1024 for all other examples), which is then subsampled by factors of 2 to obtain coarser datasets.

To evaluate the performance of WENDy, we record the relative coefficient error

$${E}_{2} := \frac{{‖ \hat{w} - {w}^{★} ‖}_{2}}{{‖ {w}^{★} ‖}_{2}}$$

as well as the forward simulation error

$${E}_{FS} := \frac{{‖ ( {U}^{★} - \hat{U} ) ‖}_{2}}{{‖ ( {U}^{★} ) ‖}_{2}}$$

TABLE 1
Specifications of ODE examples. Note that ||vec (U*)||ᵣₘₛ is included for reference in order
to compute the noise variance using σ = σ_{NR}/||vec (U*)||ᵣₘₛ.

| Name | ODE | Parameters |
|---|---|---|
| Logistic Growth | \dot{u} = w₁u + w₂u₂ | T = 10, u(0) = 0.01, |
| | | \|\|vec(U*)\|\|ᵣₘₛ = 0.66, |
| | | w* = (1, −1) |
| Lotka-Volterra | $\{ \begin{matrix}{\dot{u}}_{1} = {w}_{1} {u}_{1} + {w}_{2} {u}_{1} {u}_{2} \\ {\dot{u}}_{2} = {w}_{3} {u}_{2} + {w}_{4} {u}_{1} {u}_{2}\end{matrix}$ | T = 5, u(0) = (1, 1), \|\|vec(U*)\|\|ᵣₘₛ = 6.8, |
| | | w* = (3, −1, −6, 1) |
| Fitzhugh-Nagumo | $\{ \begin{matrix}{\dot{u}}_{1} = {w}_{1} {u}_{1} + {w}_{2} {u}_{1}^{3} + {w}_{3} {u}_{2} \\ {\dot{u}}_{2} = {w}_{4} {u}_{1} + {w}_{5} ( 1 ) + {w}_{6} {u}_{2}\end{matrix}$ | T= 25, u(0) = (0, 0.1), \|\|vec(U*)\|\|ᵣₘₛ = 0.68, |
| | | w* = (3, −3, 3, −1/3, 17/150, 1/15) |
| Hindmarsh-Rose | $\{ \begin{matrix}{\dot{u}}_{1} = {w}_{1} {u}_{2} + {w}_{2} {u}_{1}^{3} + {w}_{3} {u}_{1}^{2} + {w}_{4} {u}_{3} \\ {\dot{u}}_{2} = {w}_{5} ( 1 ) + {w}_{6} {u}_{1}^{2} + {w}_{7} {u}_{2} \\ {\dot{u}}_{3} = {w}_{8} {u}_{1} + {w}_{9} ( 1 ) + {w}_{10} {u}_{3}\end{matrix}$ | T = 10, u(0) = (−1.31, −7.6, −0.2), \|\|vec(U*)\|\|ᵣₘₛ = 2.8, w* = (10, −10, 30, −10, 10, −50, −10, 0.04, 0.0319, −0.01) |
| Protein Transduction Benchmark (PTB) | $\{ \begin{matrix}{\dot{u}}_{1} = {w}_{1} {u}_{1} + {w}_{2} {u}_{1} {u}_{3} + {w}_{3} {u}_{4} \\ {\dot{u}}_{2} = {w}_{4} {u}_{1} \\ {\dot{u}}_{3} = {w}_{5} {u}_{1} {u}_{3} + {w}_{6} {u}_{4} + {w}_{7} \frac{{u}_{5}}{0.3 + {u}_{5}} \\ {\dot{u}}_{4} = {w}_{8} {u}_{1} {u}_{3} + {w}_{9} {u}_{4} \\ {\dot{u}}_{5} = {w}_{10} {u}_{4} + {w}_{11} \frac{{u}_{5}}{0.3 + {u}_{5}}\end{matrix}$ | T = 25, u(0) = (1, 0, 1, 0, 1), \|\|vec(U*)\|\|ᵣₘₛ = 0.81, w* = (−0.07, −0.6, 0.35, 0.07, −0.6, 0.05, 0.17, 0.6, −0.35, 0.3, −0.017) |

The data Û is obtained by simulating forward the model using the learned coefficients ŵ from the exact initial conditions u(0) using the same Δt as the data. The RK45 algorithm is used for all forward simulations (unless otherwise specified) with relative and absolute tolerances of 10⁻¹². Comparison with OLS solutions is displayed in bar graphs which give the drop in error from the OLS solution to the WENDy solution as a percentage of the error in the OLS solution.

### 3.2 Summary of Results

### Logistic Growth

The logistic growth model is the simplest nonlinear model for population growth, yet the u² nonlinearity generates a bias that affects the OLS solution more strongly as noise increases. FIG. 5 (top right) indicates that when M≥256 WENDy decreases the error by 50%-85% from the OLS solution for noise level is 10% or higher. WENDy also leads to a robust fit for smaller M, providing coefficient errors E₂ and forward simulation errors E_{FS} that are both less than 6% for data with only 64 points and 10% noise (FIG. 5 [top left]) displays an example dataset at this resolution).

Referring now to FIG. 5 Logistic Growth: Estimation of parameters in the Logistic Growth model. Left and middle panels display parameter errors E₂ and forward simulation error E_{FS}, with solid lines showing mean error and dashed lines showing median error. Right: median percentage drop in E₂ from the OLS solution to the WENDy output (e.g. at 30% noise and 512 timepoints WENDy results in a 85% reduction in error).

### Lotka-Volterra

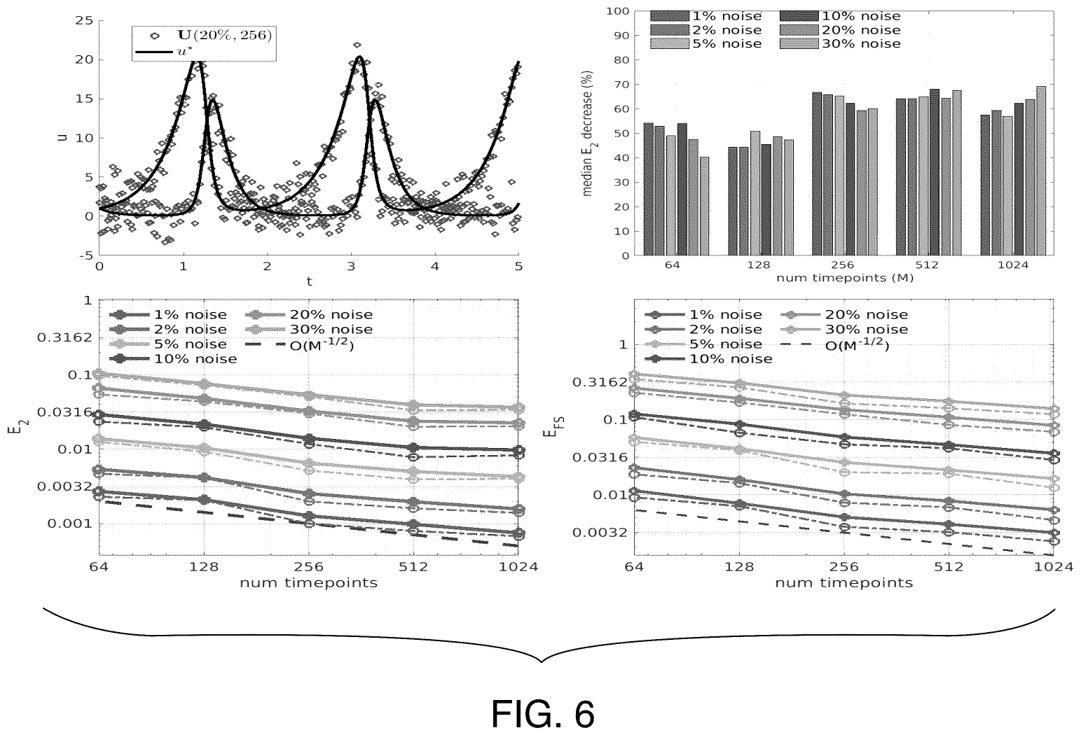

The Lotka-Volterra model is generally a system of equations designed to capture predator-prey dynamics. Each term in the model is unbiased when evaluated at noisy data (under the i.i.d. assumption), so that the first-order residual expansion utilized in WENDy is highly accurate. The bottom right plot in FIG. 6 shows even with 30% noise and only 64 timepoints, the coefficient error is still less than 10%. WENDy reduces the error by 40%-70% on average from the OLS (top right panel).

Referring now to FIG. 6 Lotka-Volterra: Estimation of parameters in the Lotka-Volterra model (for plot details see FIG. 5 caption).

### Fitzhugh-Nagumo

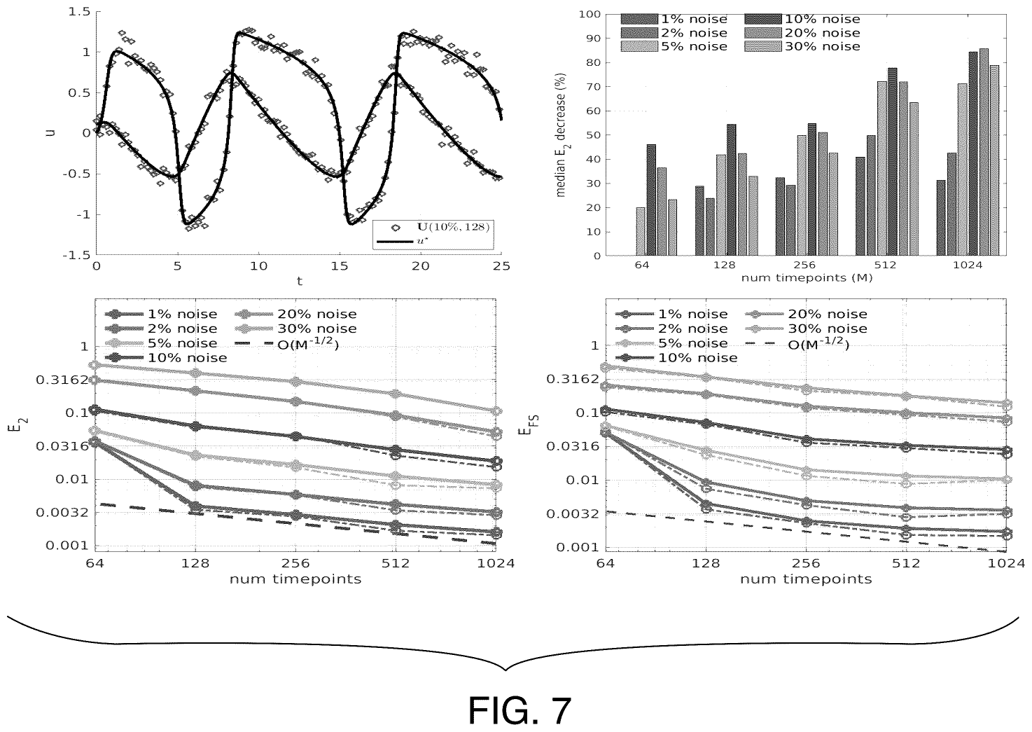

The Fitzhugh-Nagumo equations are considered a simplified model for an excitable neuron. The equations contain six fundamental terms with coefficients to be identified. The cubic nonlinearity implies that the first-order covariance expansion in WENDy becomes inaccurate at high levels of noise. Nevertheless, FIG. 7 (lower plots) shows that WENDy produces on average 6% coefficient errors at 10% noise with only 128 timepoints, and only 7% forward simulation errors (see upper left plot for an example dataset at this resolution). In many cases WENDy reduces the error by over 50% from the FSNLS solution, with 80% reductions for high noise and M=1024 timepoints (top right panel). For sparse data (e.g. 64 timepoints), numerical integration errors prevent estimation of parameters with lower than 3% error, as the solution is nearly discontinuous in this case (jumps between datapoints are 0 (1)).

Referring now to FIG. 7; FitzHugh-Nagumo: Estimation of parameters in the FitzHugh-Nagumo model (for plot details see FIG. 5 caption).

### Hindmarsh-Rose

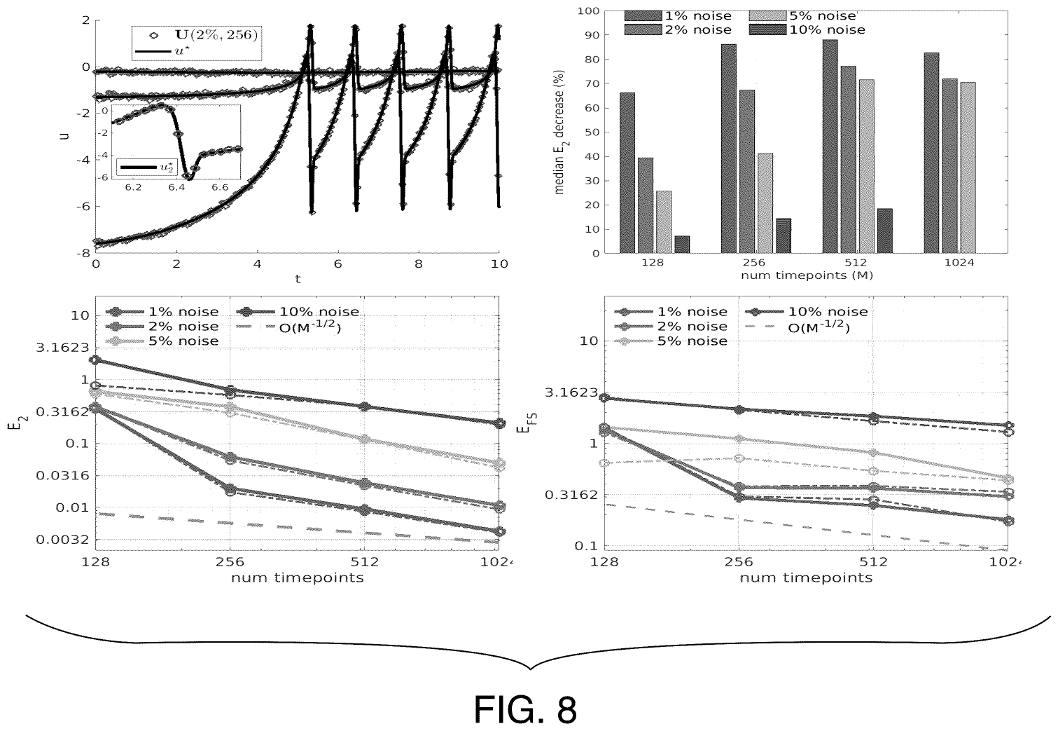

The Hindmarsh-Rose model is typically used to emulate neuronal bursting and features 10 fundamental parameters which span 4 orders of magnitude. Bursting behavior is observed in the first two solution components, while the third component represents slow neuronal adaptation with dynamics that are two orders of magnitude smaller in amplitude. Bursting produces steep gradients which render the dynamics numerically discontinuous at M=128 timepoints, while at M=256 there is at most one data point between peaks and troughs of bursts (see FIG. 8, upper left). Furthermore, cubic and quadratic nonlinearities lead to inaccuracies at high levels of noise. Thus, in a multitude of ways (multiple coefficient scales, multiple solution scales, steep gradients, higher-order nonlinearities, etc.) this is a challenging problem, yet an important one as it exhibits a canonical biological phenomenon.

FIG. 8 (lower left) shows that WENDy is robust to 2% noise when M≥256, robust to 5% noise when M≥512, and robust to 10% noise when M≥1024. It should be noted that since our noise model applies additive noise of equal variance to each component, relatively small noise renders the slowly-varying third component u₃ unidentifiable (in fact, the noise ratio of only U⁽³⁾ exceeds 100% when the total noise ratio is 10%). In the operable range of 1%-2% noise and M≥256, WENDy results in 70%-90% reductions in errors from the naive OLS solution, indicating that inclusion of the approximate covariance is highly beneficial under conditions which can be assumed to be experimentally relevant. We note that the forward simulation error here is not indicative of performance, as it will inevitably be large in all cases due to slight misalignment with bursts in the true data.

Referring now to FIG. 8—Hindmarsh-Rose: Estimation of parameters in the Hindmarsh-Rose model (for plot details see FIG. 5 caption).

### Protein Transduction Benchmark (PTB)

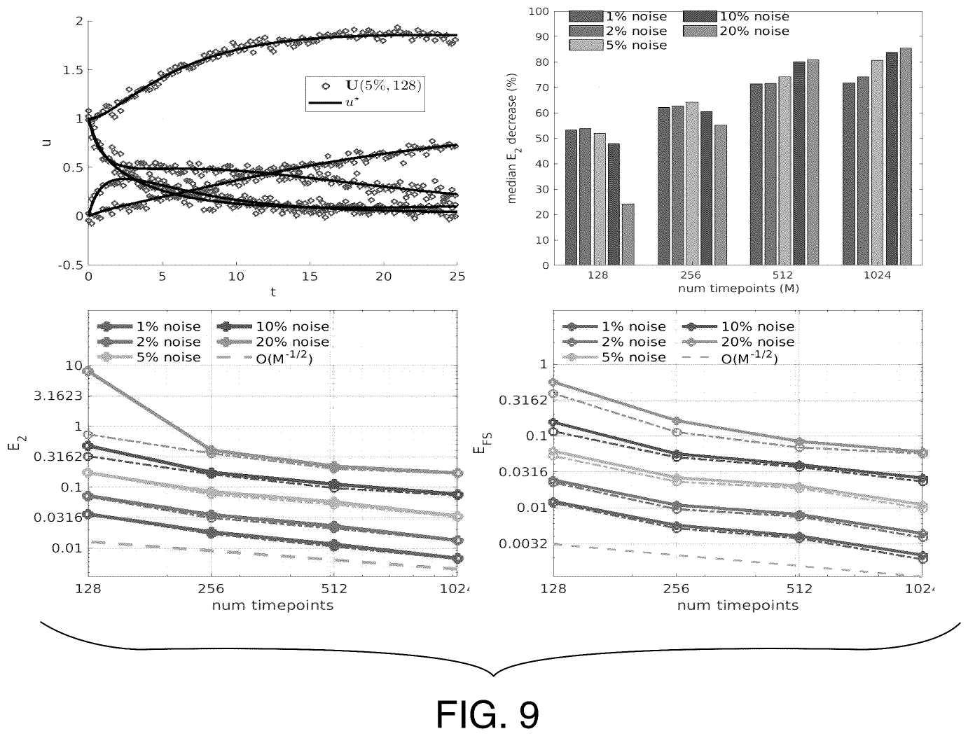

The PTB model is a five-compartment protein transduction model identified in as a mechanism in the signaling cascade of epidermal growth factor (EGF). It was used in to compare between four other models, and has since served as a benchmark for parameter estimation studies in biochemistry. The nonlinearites are quadratic and sigmoidal, the latter category producing nontrivial transformations of the additive noise. WENDy estimates the 11 parameters with reasonable accuracy when 256 or more timepoints are available (see FIG. 9), which is sufficient to result in forward simulation errors often much less than 10%. The benefit of using WENDy over the OLS solution is most apparent for M≥512, where the coefficient errors are reduced by at least 70%, leading to forward simulation errors less than 10%, even at 20% noise.

### 3.3 Parameter Uncertainties Using Learned Covariance

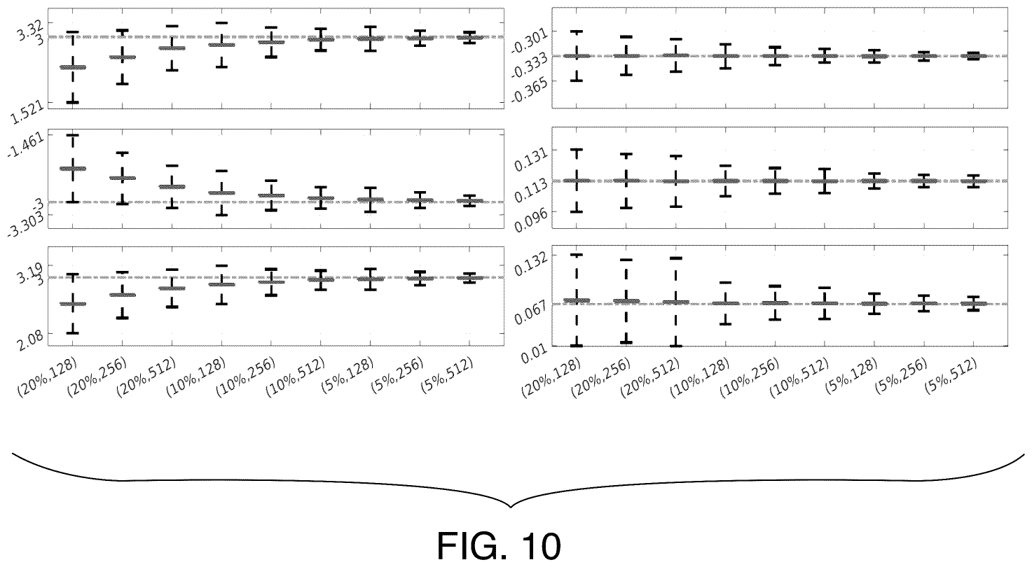

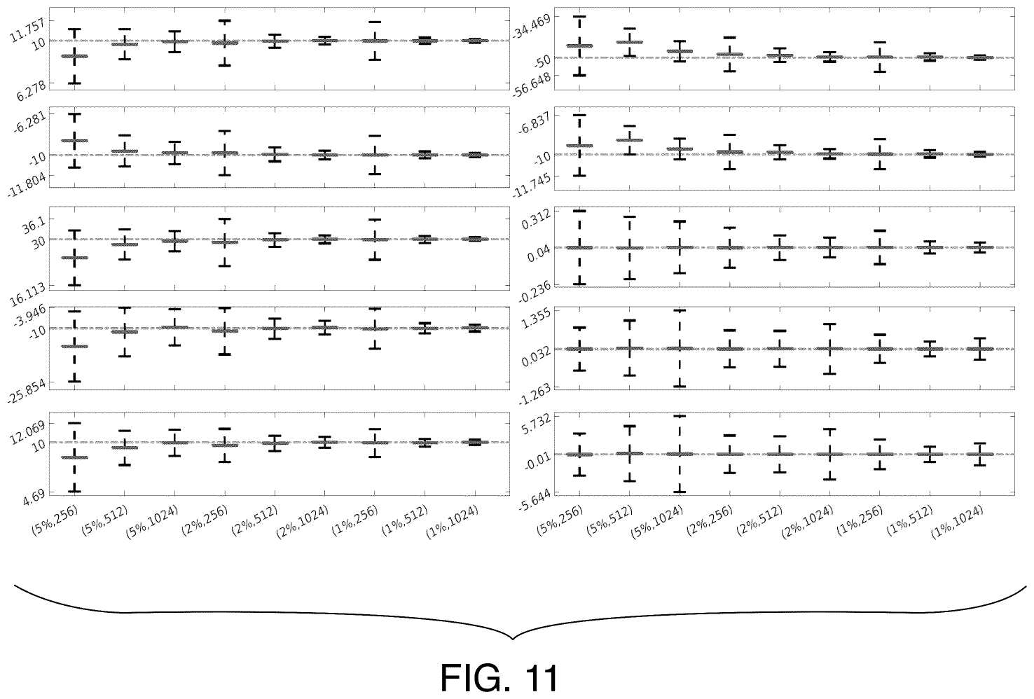

In addition to the examples presented above, the most preferred embodiments of the present invention may be used to inform the user about uncertainties in the parameter estimates. FIG. 10 and FIG. 11 contain visualizations of confidence intervals around each parameter in the FitzHugh-Nagumo and Hindmarsh-Rose models computed from the diagonal elements of the learned parameter covariance matrix S. Each combination of noise level and number of timepoints yields a 95% confidence interval around the learned parameter. As expected, increasing the number of timepoints and decreasing the noise level leads to more certainty in the learned parameters, while lower quality data leads to higher uncertainty. Uncertainty levels can be used to inform experimental protocols and even be propagated into predictions made from learned models. It would also be possible to examine the off-diagonal correlations in S, which indicate how information flows between parameters.

### 3.4 Comparison to Nonlinear Least Squares

It is now possible to briefly compare WENDy and forward solver-based nonlinear least squares (FSNLS) using walltime and relative coefficient error E₂ as criteria. For nonlinear least-squares one must specify the initial conditions for the ODE solve (IC), a simulation method (SM), and an initial guess for the parameters (w⁽⁰⁾). Additionally, stopping tolerances for the optimization method must be specified (Levenberg-Marquardt is used throughout). Optimal choices for each of these hyperparameters is an ongoing area of research. For this example, an optimized FSNLS is modeled in ways that are unrealistic in practice in order to demonstrate the advantages of the most preferred embodiments of the present invention even when FSNLS is performing somewhat optimally in both walltime and accuracy. The relevant hyperparameter selections are collected in Table 2 and discussed below.

To remove some sources of error from FSNLS, the true initial conditions u(0) are used throughout, noting that these would not be available in practice. For the simulation method, state-of-the-art ODE solvers are used for each problem, namely for the stiff differential equations Fitzhugh-Nagumo and Hindmarsh-Rose we use MATLAB's ode15s, while for Lotka-Volterra and PTB ode45 is selected. In this way FSNLS is optimized for speed in each problem. The relative and absolute tolerances of the solvers are fixed at 10⁻⁶ in order to prevent numerical errors from affecting results without asking for excessive computations. In practice, the ODE tolerance, as well as the solver, must be optimized to depend on the noise in the data, and the relation between simulation errors and parameters errors in FSNLS is an on-going area of research.

Caption for FIG. 9. Protein Transduction Benchmark (PTB): Estimation of parameters in the PTB model (for plot details see FIG. 5 caption).

Caption for FIG. 10—FitzHugh-Nagumo: Performance of WENDy for all estimated parameters. The true parameters are plotted in green, the purple lines indicate the average learned parameters over all experiments and the black lines represent the 95% confidence intervals obtained from averaging the learned parameter covariance matrices S. The x-axis indicates noise level and number of timepoints for each interval.

TABLE 2
Hyperparameters for the FSNLS algorithm.

| IC | Simulation method | w^{(0), batch} | w^{(0), WENDy} | max. evals | max. iter | min. step |
|---|---|---|---|---|---|---|
| u*(0) | L-V, PTB: ode45 | w⁽⁰⁾~U(w*, σ), | w⁽⁰⁾ = ŵ | 2000 | 500 | 10⁻⁸ |
| | FH-N, H-R: ode15s | best out of 5 | | | | |
| | (abs/rel tol = 10⁻⁶) | | | | | |

Caption for FIG. 11—Hindmarsh-Rose: Performance of WENDy for all estimated parameters. See FIG. 10 for a description.

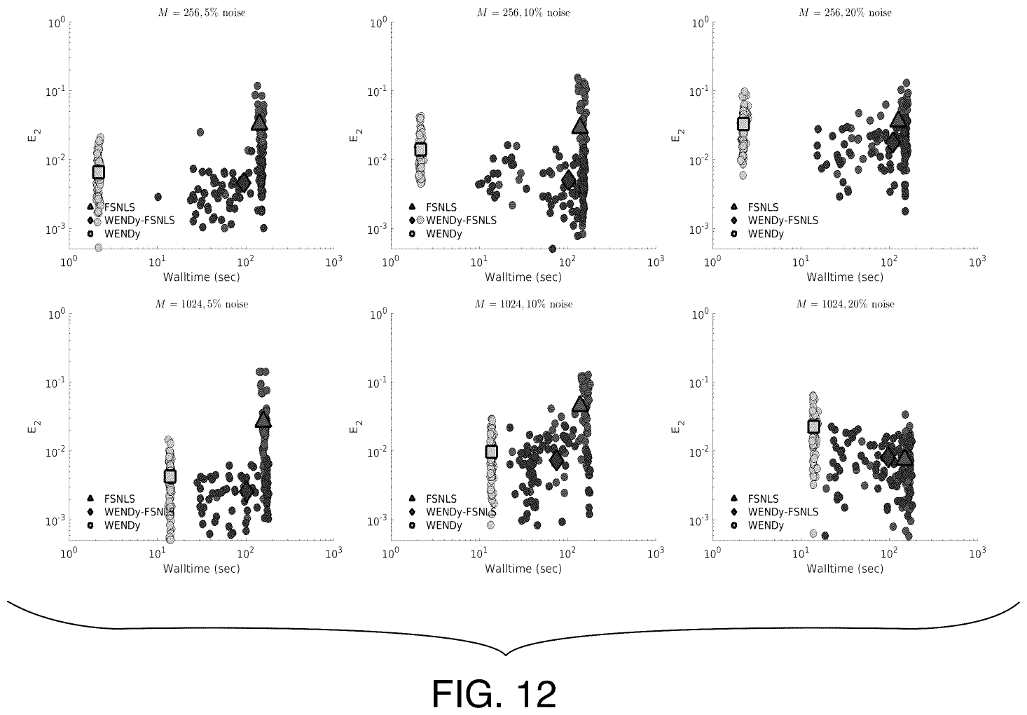

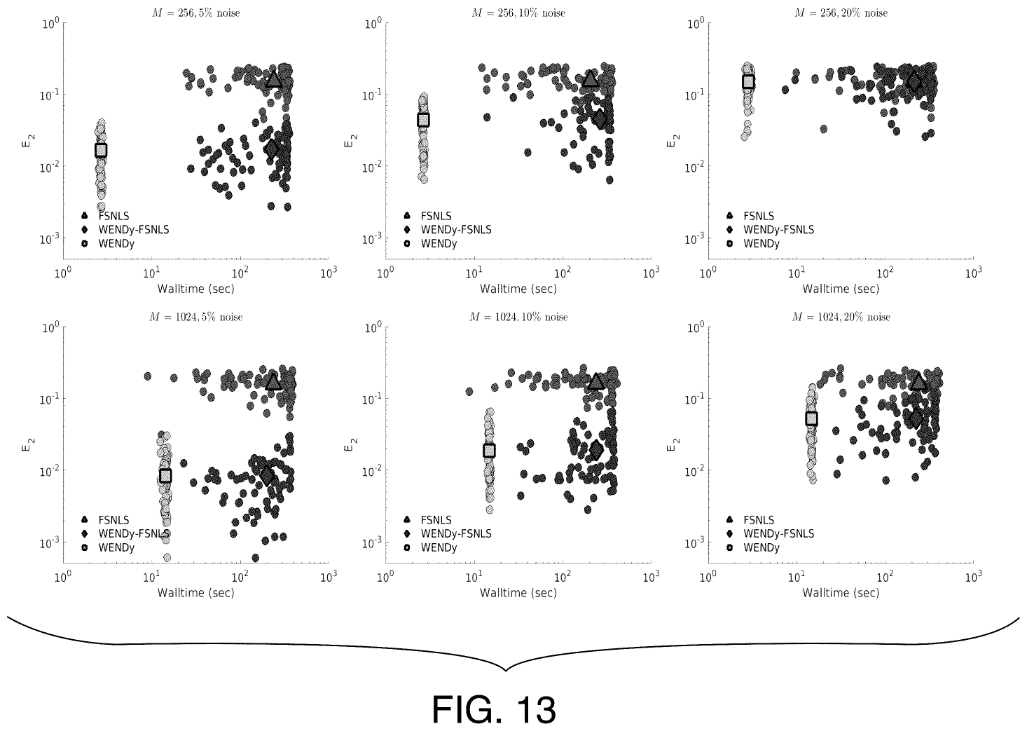

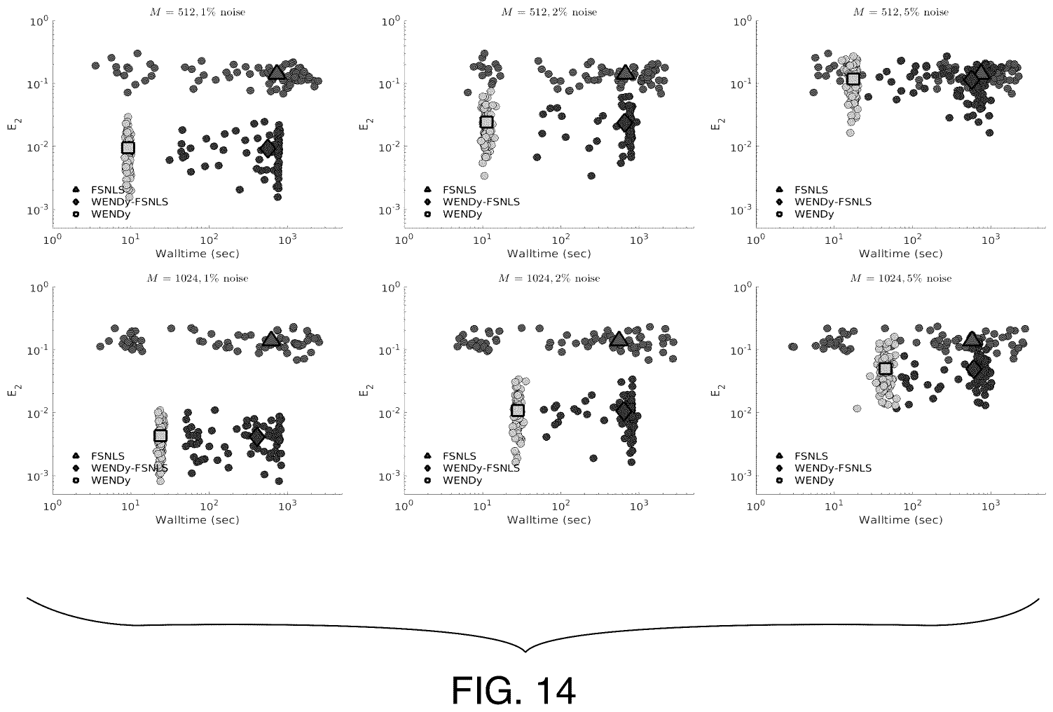

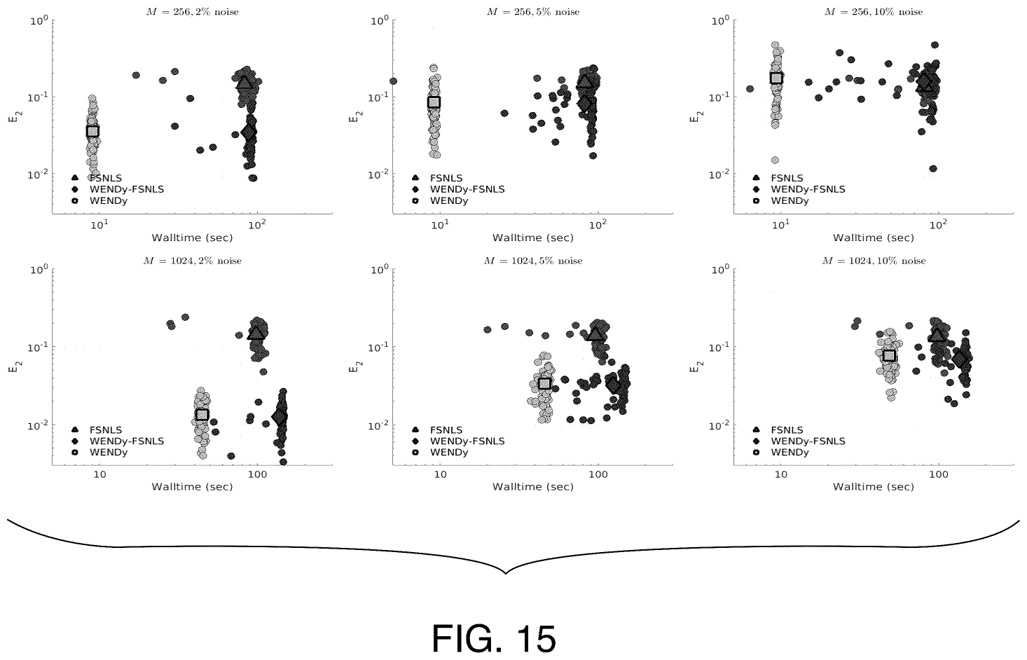

Due to the non-convexity of the loss function in FSNLS, choosing a good initial guess w⁽⁰⁾ for the parameters w* is crucial. For comparison, two strategies are employed. The first strategy (simply labeled FSNLS in FIGS. 12-15), consists of running FSNLS on five initial guesses, where each parameter is sampled i.i.d from a uniform distribution, i.e., for the i th parameter,

$${w}_{i}^{( 0 )} ∼ {w}_{i}^{★} + U ( [ - \frac{σ}{2} , \frac{σ}{2} ] )$$

and keeping only the best-performing result. Since the sign of coefficients greatly impacts the stability of the ODE, the standard deviations will be

$${σ}_{j} = 0.25 \vert {w}_{j}^{★} \vert$$

so that initial guesses always have the correct sign but with approximately 25% error from the true coefficients. (For cases like Hindmarsh-Rose, this implies that the small coefficients in w* are measured to high accuracy relative to the large coefficients.) In practice, one would not have the luxury of selecting the lowest-error result of five independent trials of FSNLS, however it may be possible to combine several results to boost performance.

For the second initial guess strategy, let w⁽⁰⁾=ŵ, the output from WENDy (labeled WENDy-FSNLS in FIGS. 12-15). In almost all cases, this results in an increase in accuracy, and in many cases, also a decrease in walltime.

FIGS. 12-15 display comparisons between FSNLS, WENDy-FSNLS, and WENDy for Lotka-Volterra, FitzHughNagumo, Hindmarsh-Rose, and PTB models. In general, it can be observed that WENDy provides significant decreases in walltime and modest to considerable increases in accuracy compared to the FSNLS solution. Due to the additive noise structure of the data, this is a surprising and unexpected result because FSNLS corresponds to (for normally distributed measurement errors) a maximum likelihood estimation, while WENDy only provides a first order approximation to the statistical model. At lower resolution and higher noise (top right plot in FIGS. 12-15), all three methods are comparable in accuracy, and WENDy decreases the walltime by two orders of magnitude. In several cases, such as Lotka-Volterra FIG. 12, the WENDy-FSNLS solution achieves a lower error than both WENDy and FSNLS, and improves on the speed of FSNLS,

Caption for FIG. 12—Comparison between FSNLS, WENDy-FSNLS, and WENDy for the Lotka-Volterra model. Left to right: noise levels {5%, 10%, 20%}. Top: 256 timepoints, bottom: 1024 timepoints. It should be noted that the M=1024 with 20% noise figure on the lower right suggests that WENDy results in slightly higher errors than the FSNLS. This is inconsistent with all other results in this work and appears to be an outlier.

For Hindmarsh-Rose, even with high-resolution data and low noise (bottom left plot of FIG. 14), FSNLS is unable to provide an accurate solution (E₂≈0.2), while WENDy and WENDy-FSNLS result in E₂≈0.005. The clusters of FSNLS runs in FIG. 14 with walltimes ≈10 seconds correspond to local minima, a particular weakness of FSNLS, while the remaining runs have walltimes on the order of 20 minutes, compared to 10-30 seconds WENDy. A similar trend in E₂ for the PTB model (FIG. 15) is exhibited, with E₂ rarely dropping below 10%, however in this case FSNLS runs in a more reasonable amount of time, taking only ≈100 seconds. The WENDy solution offers speed and error reductions. For high-resolution data (M=1024), WENDy runs in 40-50 seconds on PTB data due to the impact of M and d, the number of ODE compartments (here d=5), on the computational complexity. It is possible to reduce this using more a sophisticated implementation (in particular, symbolic computations are used to take gradients of generic functions, which could be precomputed).

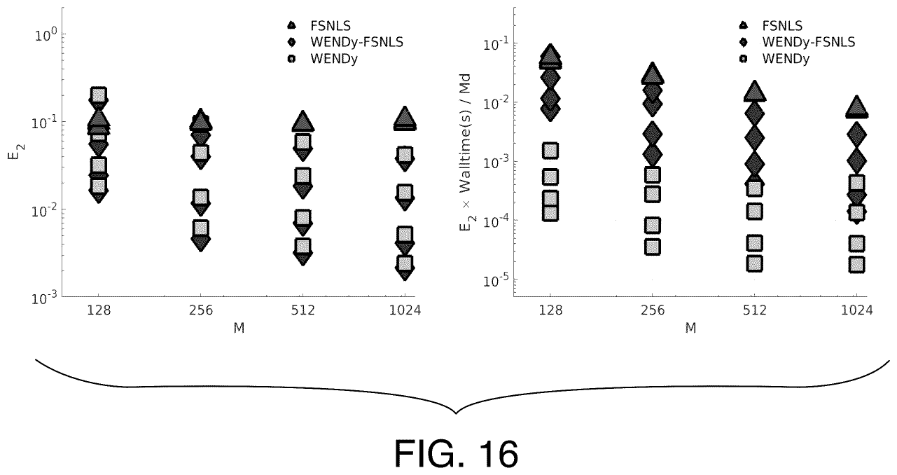

Finally, the aggregate performance of WENDy, WENDy-FSNLS, and FSNLS is reported in FIG. 16, which reiterates the trends identified in the previous Figures. Firstly, WENDy provides significant accuracy and walltime improvements over FSNLS. It is possible that FSNLS results in lower error for very small sample sizes (see M=128 results of FIG. 16), although this comes at a much higher computational cost. Secondly, WENDy-FSNLS provides similar accuracy improvements over FSNLS and improves the walltime per datapoint score, suggesting that using WENDy as an initial guess may alleviate the computational burden in cases where FSNLS is competitive.

Caption for FIG. 13—Comparison between FSNLS, WENDy-FSNLS, and WENDy for the FitzHugh-Nagumo model. Left to right: noise levels {5%, 10%, 20%}. Top: 256 timepoints, bottom: 1024 timepoints.

Caption for FIG. 14—Comparison between FSNLS, WENDy-FSNLS, and WENDy for the Hindmarsh-Rose model. Left to right: noise levels {1%, 2%, 5%}. Top: 512 timepoints, bottom: 1024 timepoints.

Caption for FIG. 15—Comparison between FSNLS, WENDy-FSNLS, and WENDy for the PTB model. Left to right: noise levels {2%, 5%, 10%}. Top: 256 timepoints, bottom: 1024 timepoints.

Caption for FIG. 16—Average performance of FSNLS, WENDy-FSNLS, and WENDy over Lotka-Volterra, FitzHugh-Nagumo, HindmarshRose and PTB for noise ratios σ_{NR}∈{0.01, 0.02, 0.05, 0.1}. To account for scaling between examples, the geometric mean across the four examples is reported in each plot. Left: average relative coefficient error E₂ vs. number of timepoints M; right: relative coefficient error E₂ multiplied by walltime per datapoint vs. M. In each case, increasing noise levels σ_{NR} correspond to increasing values along the y-axis. Both plots suggest that WENDy and WENDy-FSNLS each provide accuracy and walltime improvements over FSNLS with best-of-five random initial parameter guesses.

### 4. Conclusions

In this disclosure, it is demonstrated that the Weak-form Estimation of Nonlinear Dynamics (WENDy) method of the present invention are well-suited for directly estimating model parameters, without relying on forward solvers. The essential feature of the most preferred methods involve converting the strong form representation of a model to its weak form and then substituting in the data and solving a regression problem for the parameters. The method is robust to substantial amounts of noise, and in particular to levels frequently seen in biological experiments.

As mentioned above, the idea of substituting data into the weak form of an equation followed by a least squares solve for the parameters has existed since at least the mid 1950's. However, FSNLS-based methods have proven highly successful and are ubiquitous in the parameter estimation literature and software. The disadvantage of FSNLS is that fitting using repeated forward solves comes at a substantial computational cost and with unclear dependence on the initial guess and hyperparameters (in both the solver and the optimizer). Several researchers over the years have created direct parameter estimation methods (that do not rely on forward solves), but they have historically included some sort of data smoothing step. The primary issue with this is that projecting the data onto a spline basis (for example) represents the data using a basis which does not solve the original equation. Importantly, that error propagates to the error in the parameter estimates. However, we note that the WENDy framework introduced here is able to encapsulate previous works that incorporate smoothing, namely by including the smoothing operator in the covariance matrix C.

The conversion to the weak form is essentially a weighted integral transform of the equation. As there is no projection onto a non-solution based function basis, the weak-form approach bypasses the need to estimate the true solution to directly estimate the parameters.

One of the most salient and unique aspects of the present invention is the teaching that the weak-form-based direct parameter estimation methods disclosed herein significant advantages over traditional FSNLS-based methods. In almost all the examples disclosed herein and, in particular for larger dimensional systems with high noise, the unique methods of the present invention are faster and more accurate by orders of magnitude. In rare cases where an FSNLS-based approach yields higher accuracy, the methods of the present invention may still be used as an efficient method to identify a good initial guess for parameters.

It is to be understood that although aspects of the present specification are highlighted by referring to one or more specific embodiments, those skilled in the art will readily appreciate that these disclosed embodiments are only illustrative of the principles of the subject matter disclosed herein. For example, although the disclosure refers to the various preferred embodiments of the present invention primarily in conjunction with certain models for specific applications, those skilled in the art will recognize that the various embodiments of the present invention are suitable for use in conjunction with other models and applications where more accurate estimation of variables and parameters for various models is desirable.

Therefore, it should be understood that the disclosed subject matter is in no way limited to a particular methodology, protocol, and/or material, etc., described herein. As such, various modifications or changes to or alternative configurations of the disclosed subject matter can be made in accordance with the teachings herein without departing from the spirit of the present specification. Further, the terminology used herein is for the purpose of describing particular embodiments only, and is not intended to limit the scope of the present disclosure, which is defined solely by the claims. Accordingly, embodiments of the present disclosure are not limited to those precisely as shown and described.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the embodiments otherwise claimed. No language in the present specification should be construed as indicating any non-claimed element essential to the practice of the disclosed embodiments.

1. A method for estimating model parameters for non-linear systems of Ordinary Differential Equations (ODEs), the method comprising:
receiving data from one or more non-linear systems of ODEs;
applying one or more Weak-form Estimation of Nonlinear Dynamics (WENDy) methods to the received data, wherein the WENDy methods are robust to one or more instances of large measurement noise;
converting one or more strong form representations of a model to one or more weak forms;
solving one or more regression problems to perform parameter inference; and
using one or more Errors-In-Variables frameworks and one or more iteratively reweighted least squares algorithms.

2. The method of claim 1, further comprising the step of creating a plurality of orthonormal test functions from a plurality of Coo bump functions of varying support sizes.

3. The method of claim 1, wherein the non-linear systems of ODEs are low dimensional systems with modest amounts of data.

4. The method of claim 1, wherein the non-linear systems of ODEs are higher dimensional systems.

5. The method of claim 1, wherein the non-linear systems of ODEs are stiff systems.

6. The method of claim 1, wherein the WENDy methods are competitive with one or more forward solver-based nonlinear least squares methods in terms of speed and accuracy for low dimensional systems.

7. The method of claim 1, wherein the WENDy methods are faster and more accurate than one or more forward solver-based nonlinear least squares methods for higher dimensional systems and stiff systems.

8. The method of claim 2, wherein the Co bump functions have varying support sizes.

9. The method of claim 1, further comprising the step of applying the WENDy methods to estimate parameters in one or more models from population biology.

10. The method of claim 1, further comprising the step of applying the WENDy methods to estimate parameters in one or more models from neuroscience.

11. The method of claim 1, further comprising the step of applying the WENDy methods to estimate parameters in one or more models from biochemistry.

12. The method of claim 1, further comprising the step of applying the WENDy methods to estimate parameters in one or more models of logistic growth.

13. The method of claim 1, further comprising the step of applying the WENDy methods to estimate parameters in one or more models of Lotka-Volterra.

14. The method of claim 1, further comprising the step of applying the WENDy methods to estimate parameters in one or more models of FitzHugh-Nagumo.

15. The method of claim 1, further comprising the step of applying the WENDy methods to estimate parameters in one or more models of Hindmarsh-Rose.

16. The method of claim 1, further comprising the step of applying the WENDy methods to estimate parameters in one or more Protein Transduction Benchmark models.

17. A system for estimating model parameters for non-linear systems of Ordinary Differential Equations (ODEs), the system comprising:
a data receiver configured to receive data from one or more non-linear systems of ODEs;
a processor configured to apply one or more Weak-form Estimation of Nonlinear Dynamics (WENDy) methods to the received data, wherein the WENDy methods are robust to one or more instances of large measurement noise, to convert one or more strong form representations of a model to one or more weak forms, and to solve one or more regression problems to perform parameter inference; and
a memory configured to store one or more Errors-In-Variables frameworks and one or more iteratively reweighted least squares algorithms.

18. The system of claim 17, wherein the processor is further configured to create a plurality of orthonormal test functions from a plurality of Co bump functions of varying support sizes.

19. The system of claim 17, wherein the non-linear systems of ODEs are low dimensional systems with relatively modest amounts of data.

20. The system of claim 17, wherein the non-linear systems of ODEs are higher dimensional systems.
